(19) United States
(12) Patent Application Publication
(10) Pub. No.: US 2024/0406317 A1
(43) Pub. Date: Dec. 5, 2024

(54) PRINTING APPARATUS, PRINTING METHOD, AND STORAGE MEDIUM

(71) Applicant: CANON KABUSHIKI KAISHA, Tokyo (JP)

(72) Inventors: Tatsuya Tanaka, Tokyo (JP); Jun Yasutani, Kanagawa (JP)

(21) Appl. No.: 18/678,174

(22) Filed: May 30, 2024

(30) Foreign Application Priority Data
Jun. 5, 2023 (JP) 2023-092523

(51) Int. Cl. H04N 1/00

(52) U.S. Cl. CPC H04N 1/00045; H04N 1/00018

(57) ABSTRACT

The technique of the present disclosure adjusts print positions properly even if a test chart printed on a printing medium is scanned in a divided manner. A print controller converts the representative positions of patches for printing element substrates on first and second scan images into position difference information in relation to an origin located in overlap regions of the scan images. Based on position difference information for the second scan image and an extension/contraction rate, the print controller converts the position difference information for the second scan image to bring the extension/contraction rate to 1, which means making a distance between particular patterns on the second scan image equal to a distance between the same particular patterns on the first scan image. On the first scan image, the print controller calculates a tilt of a reference line used to calculate amounts of positional shift between the printing element substrates.

### BACKGROUND

### Field

The present invention relates to a control technique for adjusting print positions in a printing apparatus.

### Description of the Related Art

There are known printing apparatuses that use what is called a full-line printhead, the print width of which corresponds to the width of a printing medium, and one of such printing apparatuses is an inkjet printing apparatus. A full-line printhead in an inkjet printing apparatus has a plurality of printing element substrates each including a plurality of nozzle arrays, and the inkjet printing apparatus can print an image on almost the entire surface of a printing medium by moving the printhead relative to the printing medium once. A printing apparatus provided with a full-line printhead may have error in the attachment position of the printhead or the attachment positions of a plurality of printheads relative to each other. This error can cause shift of the positions of a printing material attaching to a printing medium (ink landing positions in an inkjet printing apparatus) and become a factor in lowering print quality. Hereinafter, processing to correct such shift of printing material attachment positions is called “print position adjustment.”

In print position adjustment, first, test charts printed on a printing medium are scanned using a scanner device having an image sensor, and from a scan image thus obtained, the positions of patches that are included in the test chart and correspond to printing element substrates and their nozzle arrays are detected. Then, the relative positions of the patterns are found, and the print positions are adjusted based on the relative positions. As a method to improve the patch position detection accuracy, Japanese Patent Laid-Open No. 2020-172084 discloses a method for performing print position adjustment based on amounts of positional shift between the printing element substrates, the amount of positional shift of each printing element substrate being found based on the distance between the printing element substrate and a reference line connecting estimated positions of two printing element substrates located close to the respective end portions of the printhead.

In a case of performing wide-format printing with an inkjet printing apparatus using a full-line printhead, the printhead needs to be as large as a printing medium. The larger the printhead, the larger the test chart for print position adjustment, and thus, the scanner device needs to be able to cover a scan size corresponding to the size of the test chart. Some scanner devices that support large scan size use a combination of a plurality of image sensors.

However, in a case where a scanner device using a combination of a plurality of image sensors is used in the technique in Japanese Patent Laid-Open No. 2020-172084, the positions of the two printing element substrates close to the end portions of the printhead that are used to find the reference line have to be estimated based on two scan images obtained under different scan conditions. This consequently lowers the accuracy of the estimation of the relative positions of the two print element substrates for finding the reference line, which in turn lowers the accuracy of the reference line and therefore hinders proper print position adjustment.

Thus, the present invention aims to perform print position adjustment properly even in a case where a test chart printed on a printing medium is scanned into separate images.

### SUMMARY

The present invention is a printing apparatus having a printing unit or a plurality of the printing units including a plurality of printing element substrates that apply a printing material to a printing medium, the printing apparatus including: a scan control unit that causes a scan device to scan a test chart in a divided manner with a plurality of optical sensors, the test chart being printed on the printing medium by the printing unit and including a plurality of patches corresponding to the respective printing element substrates; a calculation unit that, based on a plurality of scan images obtained by the scan device by scanning the test chart printed on the printing medium, calculates a rate of extension or contraction of the patches corresponding to the printing element substrates included in the same printing unit, the rate of extension/contraction being between a pair of scan images formed by two of the plurality of scan images; and an adjustment unit that adjusts positions where the printing material applied from the printing unit attaches to the printing medium based on the rate of extension or contraction calculated by the calculation unit positional information on the patches on the plurality of scan images.

Further features of the present disclosure will become apparent from the following description of exemplary embodiments with reference to the attached drawings.

### BRIEF DESCRIPTION OF THE DRAWINGS

FIG. 1 is an outline of an inkjet printing apparatus;

FIG. 2 is an overhead view of a scanner device scanning test charts, seen from above the scanner device;

FIG. 3 is a block diagram showing a hardware configuration for controlling the inkjet printing apparatus;

FIG. 4 is a diagram illustrating a patch for correcting positional shift between nozzle arrays;

FIG. 5A is a diagram showing an example pattern for pattern matching;

FIG. 5B is a diagram showing an example pattern for pattern matching;

FIG. 6 shows the positional relations between the scanner device, test charts, and printheads;

FIG. 7 is a diagram illustrating a test chart for correcting head position shift;

FIG. 8A is a diagram illustrating how to calculate amounts of positional shift between the nozzle arrays;

FIG. 8B is a diagram illustrating how to calculate amounts of positional shift between the nozzle arrays;

FIG. 9A is a diagram illustrating how to calculate amounts of positional shift between printing element substrates;

FIG. 9B is a diagram illustrating how to calculate amounts of positional shift between printing element substrates;

FIG. 10A is a diagram illustrating how to calculate an amount of tilt of a printhead;

FIG. 10B is a diagram illustrating how to calculate an amount of tilt of a printhead;

FIG. 10C is a diagram illustrating how to calculate an amount of tilt of each printhead;

FIG. 11A is a diagram illustrating how to calculate amounts of positional shift between the printheads;

FIG. 11B is a diagram illustrating how to calculate amounts of positional shift between the printheads;

FIG. 12 is a diagram illustrating detection of a detection mark on a patch for a printing element substrate;

FIG. 13 is a diagram showing an example of two scan images obtained by two sensors in the scanner device;

FIG. 14 is a flowchart illustrating shift amount calculation processing according to the present embodiment;

FIG. 15 is a flowchart illustrating shift amount calculation processing 1 according to the present embodiment;

FIG. 16A is a diagram illustrating a procedure for calculating a rate of extension/contraction between scan images;

FIG. 16B is a diagram illustrating a procedure for calculating a rate of extension/contraction between scan images;

FIG. 16C is a formula for calculating a rate of extension/contraction between scan images;

FIG. 17 is a flowchart illustrating shift amount calculation processing 2 according to the present embodiment;

FIG. 18A is a diagram illustrating a procedure according to the present embodiment for correcting position difference information on each printing element substrate on one of the scan images using a corresponding rate of extension/contraction;

FIG. 18B is a diagram illustrating a procedure according to the present embodiment for correcting position difference information on each printing element substrate on one of the scan images using a corresponding rate of extension/contraction;

FIG. 19A is a diagram illustrating a procedure for obtaining a reference line according to the present embodiment;

FIG. 19B is a diagram illustrating a procedure for obtaining a reference line according to the present embodiment;

FIG. 20A is a diagram illustrating a procedure according to the present embodiment for correcting a tilt of a reference line and calculating coordinates of each printing element substrate on a second scan image, based on the coordinate system of a first scan image; and

FIG. 20B is a diagram illustrating a procedure according to the present embodiment for correcting a tilt of a reference line and calculating coordinates of each printing element substrate on a second scan image, based on the coordinate system of a first scan image.

### DESCRIPTION OF THE EMBODIMENTS

The present embodiment is described with reference to the drawings. Note that constituents described in this embodiment are used to show an example mode of the present invention, and the scope of the present invention is not limited only to them.

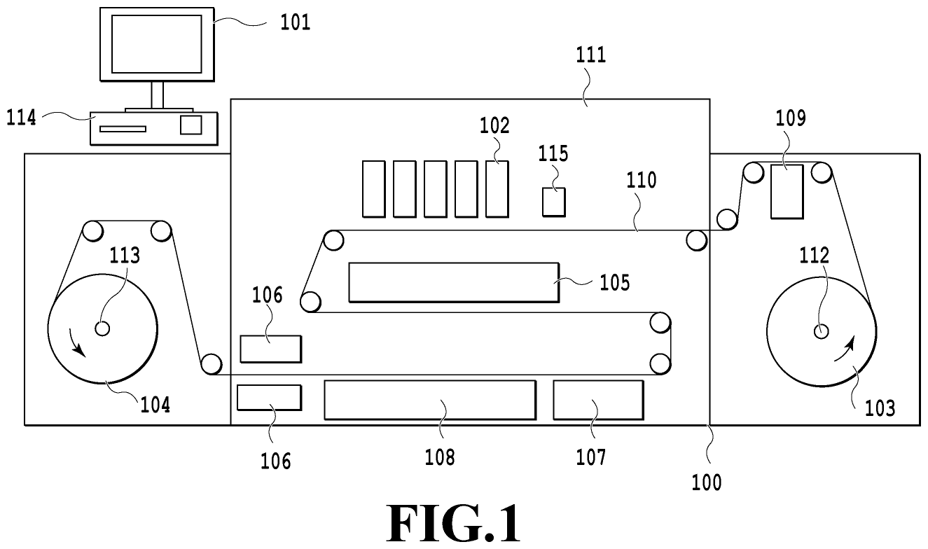

FIG. 1 is a front view schematically showing an inkjet printing apparatus 100 according to the present embodiment. The inkjet printing apparatus 100 is an apparatus that prints an image on a continuous sheet of paper (called roll paper hereinbelow) 110 on which continuous printing can be done and which is used in the present embodiment. In the present embodiment, the inkjet printing apparatus 100 is formed by a paper feed device 103 that conveys the roll paper 110, a main unit 111 that performs printing, a paper discharge device 104 that winds up the roll paper 110, and an operation panel 101.

The paper feed device 103 is a device that supplies the roll paper 110 to the main unit 111. The paper feed device 103 rotates the paper core of the roll paper 110 about a rotary shaft 112 and thereby conveys the roll paper 110 wound on the paper core to the main unit 111 at a certain speed via a plurality of rollers (such as conveyance and paper feed rollers).

The paper discharge device 104 is a device that winds up the roll paper 110 conveyed from the main unit 111 around a paper core into a roll. For example, as shown in FIG. 1, in the paper discharge device 104, the roll paper 110 is wound around a paper core on a rotary shaft 113 and held in the shape of a roll. The paper discharge device 104 is a device that rotates the rotary shaft 113 to wind the roll paper 110 conveyed thereto around a paper core at a certain speed via a plurality of rollers (e.g., conveyance and paper discharge rollers), thereby obtaining a roll paper deliverable. Before printing is started, the roll paper 110 is passed from the paper feed device 103 to the paper discharge device 104. The roll paper 110 is set in the paper feed device 103, and the leading edge of the roll paper 110 is passed above a skew correction device 109. Next, the roll paper 110 is passed under inkjet printheads 102 in the main unit 111, then under a dryer device 105, and then above cooler devices 107, 108. The roll paper 110 is then passed through a scanner device 106 and wound up by the paper discharge device 104.

The scanner device 106 optically scans a print pattern and the like printed on roll paper using optical sensors. After the roll paper 110 is passed through the inkjet printing apparatus 100, a print job is given to a control PC 114 of the inkjet printing apparatus 100. After the print job is given, printing is started upon pressing of a START PRINT button on the operation panel 101.

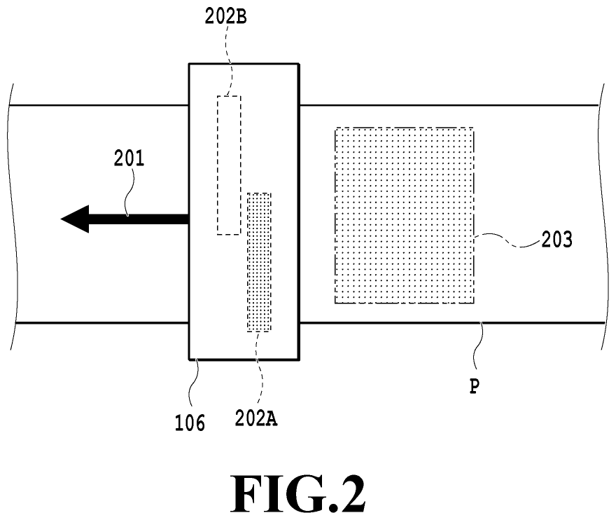

FIG. 2 is an overhead view of the scanner device 106 scanning a test chart, seen from above the scanner device. A printing medium P, which is the roll paper 110, is conveyed in a conveyance direction 201 and is adjusted in its conveyance speed near the scanner device 106, so that an image of an image-capture region 203 is captured using sensors 202A and 202B, which are optical sensors. The sensor 202A and the sensor 202B are disposed in a zigzag manner on a side surface of the scanner device 106 facing the printing medium P, while partly overlapping with the image capture region. Disposed in a zigzag manner, the sensor 202A and the sensor 202B are spaced away from each other in the conveyance direction 201. The sensor 202A and the sensor 202B include an imaging element (not shown) such as, for example, a CCD sensor or a CMOS sensor. Scan images of the image-capture region 203 obtained by the scanner device 106 are used for calculation of various correction values. How correction values are calculated will be described later. Note that the scanner device 106 may be configured to be preinstalled in the main unit 111 or to be attachable as an option.

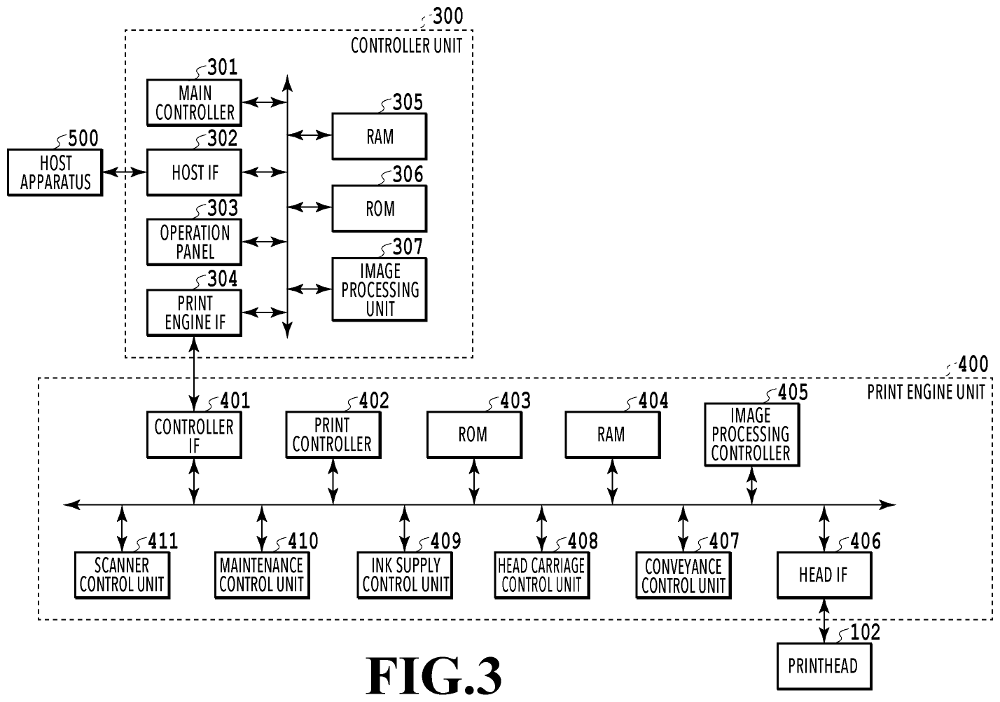

FIG. 3 is a block diagram showing a hardware configuration for control of the inkjet printing apparatus 100. The control configuration is mainly formed by a print engine unit 400 that performs overall control of a print engine and a controller unit 300 that performs overall control of the inkjet printing apparatus. A print controller 402 controls various mechanisms of the print engine unit 400 as instructed by a main controller 301 of the controller unit 300. The following describes details of the control configuration.

In the controller unit 300, the main controller 301, which is formed of a CPU, controls the entire inkjet printing apparatus 100 according to programs and various parameters stored in a ROM 306 while using a RAM 305 as work space. For example, once a print job is inputted from a host device 500 via a host I/F 302, an image processing unit 307, as instructed by the main controller 301, performs predetermined image processing on image data received. Then, the main controller 301 transmits the image data obtained by the image processing to the print engine unit 400 via a print engine I/F 304.

Note that the inkjet printing apparatus 100 may obtain the image data to be transmitted to the print engine unit 400 from an external storage device (such as USB memory) connected to the inkjet printing apparatus 100. An operation panel 303 is a mechanism for a user to input information to the printing apparatus or receive output from the printing apparatus. Through the operation panel 303, a user can instruct a print operation or paper feed operation, set a printing mode, or check information on the printing apparatus. The operation panel 303 is a touch panel, and it is also possible to connect and use a mouse or keyboard to input instructions.

In the print engine unit 400, the print controller 402, which is formed of a CPU, controls various mechanisms in the inkjet printing apparatus 100 according to programs and various parameters stored in a ROM 403. For this control, the print controller 402 uses a RAM 404 as workspace. Upon receipt of a command of various kinds or image data via a controller I/F 401, the print controller 402 saves it in the RAM 404 temporarily. In order for the printheads 102 to use the image data for a print operation, the print controller 402 causes an image processing controller 405 to convert the image data saved in the RAM 404 into print data. Once the print data is generated, the print controller 402 causes, via a head I/F 406, the printheads 102 to execute a print operation based on the print data. In this event, the print controller 402 causes a conveyance control unit 407 to drive the paper feed device 103 and the paper discharge device 104 shown in FIG. 1 to convey the roll paper 110, which is a printing medium. The print controller 402 also causes the conveyance control unit 407 to drive a heater and a fan in the dryer device 105 and the cooler devices 107, 108 to dry and cool the sheet conveyed. Further, the conveyance control unit 407 can detect an amount of conveyance using an encoder in the conveyance rollers. As instructed by the print controller 402, the printheads 102 execute a print operation in conjunction with a roll paper conveyance operation, thereby performing printing processing.

The printheads 102 are configured to move up and down (in a direction perpendicular to the print surface of the roll paper 110): the printheads 102 are lowered during printing and raised during maintenance and the like. A head carriage control unit 408 changes the vertical position of the printheads 102 according to the operation mode of the inkjet printing apparatus 100, such as maintenance mode or printing mode. An ink supply control unit 409 controls the ink supply unit so that the pressure of ink supplied to the printheads 102 may fall within a proper range. In an event where a maintenance operation is performed on the printheads 102, a maintenance control unit 410 moves a maintenance unit under the heads which have been raised and controls the head maintenance operation such as capping and wiping.

A scanner control unit 411 controls the scanner device 106. In a case where the image data on which a print operation is to be performed is test charts, which are patterns used to calculate various correction values, the print controller 402 instructs the conveyance control unit 407 to adjust the conveyance speed. Further, instructed by the print controller 402 of timing to scan test charts printed on the roll paper, the scanner control unit 411 saves, in the RAM 404, scan images captured and obtained by the scanner device 106. The print controller 402 executes processing to calculate various correction values using the scan images thus saved. Correction values thus obtained are passed from the print controller 402 to the image processing controller 405 and are reflected in the print operation. Note that the following configuration is also possible: the scan images saved are transferred to the host device 500 via the controller unit 300, and the host device 500 executes the processing to calculate various correction values and outputs correction values obtained to the print controller 402.

The following describes details of how to correct positional shift of the printheads, which is one of the various correction values.

(How to Correct Positional shift of the Printheads)

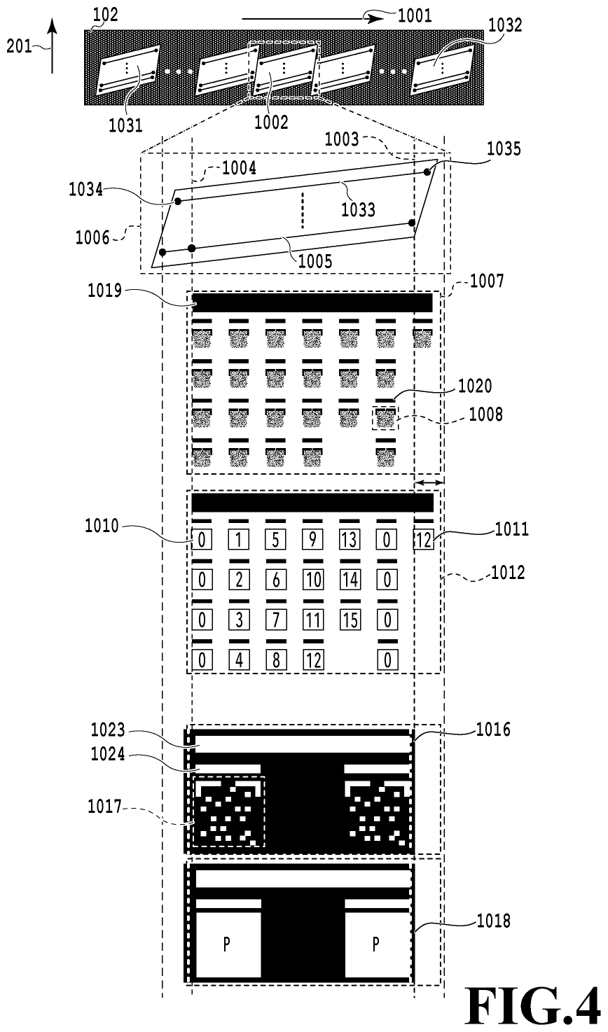

FIG. 4 is a diagram showing correspondences between a patch 1007, 1016 and nozzles corresponding to one of printing element substrates 1002 forming the printhead 102. Each printhead 102 is formed by a plurality of printing element substrates 1002. Each printing element substrate 1002 is formed by a plurality of nozzles each configured to eject ink by having its printing element driven. A printing element for ejecting ink may be a heater or a piezoelectric element. In the example shown in the present embodiment, the printing element substrate is shaped like a parallelogram and has a plurality of nozzle arrays arranged thereon. A nozzle array direction 1001, which is a direction in which the plurality nozzles are arrayed, intersects with the conveyance direction 201 and corresponds to the width direction of a printing medium. In a close-up 1006 of the printing element substrate 1002, the printing element substrate 1002 includes a plurality of nozzle arrays 1005 each formed by a plurality of nozzles. A test chart for a single printing element substrate 1002 is printed using nozzles of the nozzle arrays 1005 on the printing element substrate 1002, the nozzles being the ones within an area sandwiched by broken lines 1003 and 1004. This area may be changed depending on the configuration of the printing element substrate 1002.

In the example shown in the present embodiment, each printhead is formed by 17 printing element substrates 1002, each of which is formed by 16 nozzle arrays 1005. Each nozzle array is formed by 512 nozzles. Note that the number of printing element substrates 1002 forming each printhead, the number of nozzle arrays 1005 forming each printing element substrate 1002, and the number of nozzles forming each nozzle array 1005 are not limited to the above.

For the sake of convenience, the n-th (n≥0) printing element substrate 1002 as counted from the left in the nozzle array direction 1001 is referred to as Cn, and the n-th (n>0) nozzle array 1005 as counted from the downstream side in the conveyance direction 201 is referred to as Rn. For instance, a printing element substrate 1031 is C0 because it is located at the leftmost end in the nozzle array direction 1001, and a printing element substrate 1032 is C16 because it is located at the rightmost end. Similarly, a nozzle array 1005 is R15 because it is located at the most upstream side in the conveyance direction 201, and a nozzle array 1033 is R0 because it is located at the most downstream side. The nozzle array 1033 is formed by 512 nozzles (not shown), the leftmost one of which is a nozzle 1034 and the rightmost one of which is a nozzle 1035. The other nozzle arrays are formed by 512 nozzles as well.

The patch 1007 is one of patches corresponding to a single printing element substrate 1002 and is designed to include a detection mark 1019, alignment marks 1020, and patterns 1008 for pattern matching.

The patterns 1008 for pattern matching included in the patch 1007 are provided in correspondence to the respective nozzle arrays. Here, the patterns 1008 for pattern matching are printed using different nozzle arrays 1005 from each other. In other words, 0th to 15th patterns 1008 for pattern matching are provided for the 16 nozzle arrays 1005. A layout 1012 shows the arrangement of the patterns 1008 for pattern matching for the nozzle arrays 1005. Rectangles 1010 corresponding to the respective patterns 1008 for pattern matching each have a numerical value written thereon, the numerical value indicating the nozzle array 1005 that prints the pattern 1008 for pattern matching at that position. For instance, the rectangle 1010 corresponding to the pattern 1008 for pattern matching printed by the R0-th nozzle array 1005 has “0” written thereon. In this way, a number written inside a rectangle is the numerical value n in Rn denoting the nozzle array 1005 that prints the pattern 1008 for pattern matching corresponding to the rectangle. Positional shift is calculated based on relative positions between the patterns 1008 for pattern matching printed by the R0-th nozzle array 1005 used as a reference and the patterns 1008 for pattern matching printed by the other nozzle arrays 1005. As an exception, a pattern for pattern matching corresponding to a rectangle 1011 is provided. This is the pattern 1008 for pattern matching printed by the R12-th nozzle array 1005 on the (Cn+1)-th printing element substrate 1002, which is on the right side of the Cn-th printing element substrate 1002 shown in the close-up 1006. Note that the nozzle array 1005 which is on the adjacent printing element substrate 1002 and prints the pattern 1008 for pattern matching corresponding to the rectangle 1011 is not limited to R12. The nozzle array 1005 to print the pattern 1008 for pattern matching corresponding to the rectangle 1011 may be changed depending on the number of nozzle arrays 1005 forming each printing element substrate 1002, the shape of the printing element substrates 1002, and the like.

Also, regions in black are regions printed by corresponding ink, and regions in white are the background color of the printing medium and are regions not printed by ink.

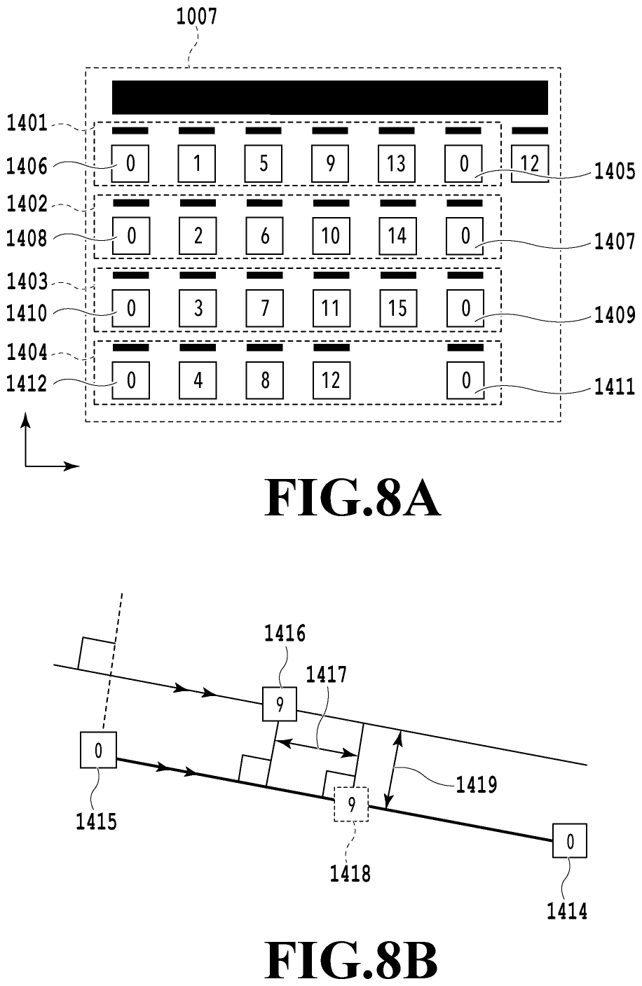

The patterns 1008 for pattern matching for the respective nozzle arrays 1005 on the patch 1007 are used to calculate positional shifts of the nozzle arrays 1005 on the printing element substrate 1002 that printed the patch 1007 due to manufacturing error. Details will be described later using FIGS. 8A and 8B. Note that the pattern for pattern matching corresponding to the rectangle 1011 is printed by the printing element substrate 1002 different from the printing element substrate 1002 used to print the other patterns 1008 for pattern matching and is not used for the calculation of positional shifts of the nozzle arrays on the printing element substrate 1002.

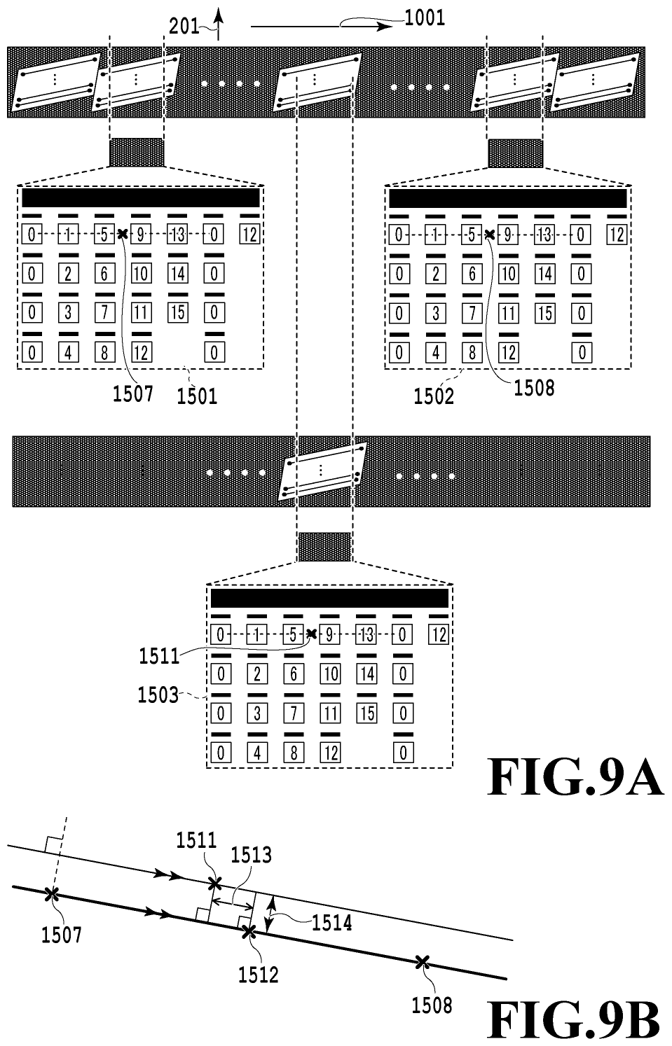

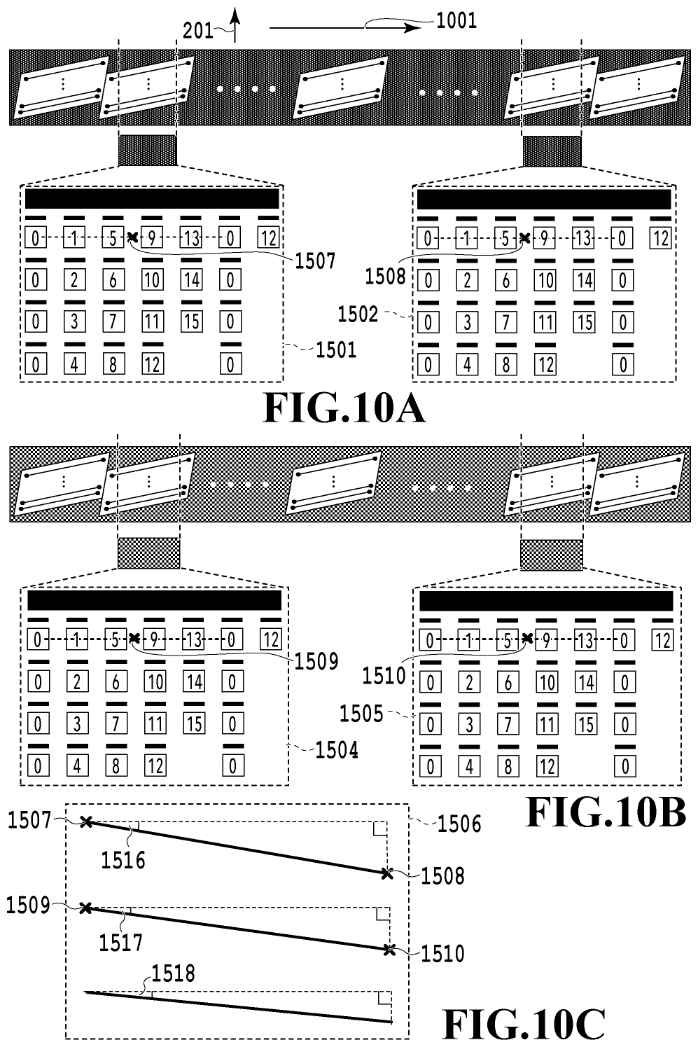

The patches 1007 are also used in calculating positional shifts between the printing element substrates 1002 and the tilts of the printheads 102. Positional shifts between a plurality of printing element substrates 1002 on the same printhead 102 and the tilt of the printhead 102 are calculated in reference to a line segment connecting the representative position of the second patch 1007 from the leftmost one and the representative position of the second patch 1007 from the rightmost one, as counted inward. Details will be described later using FIGS. 9A, 9B, and 10A to 10C.

Note that in the apparatus according to the present embodiment, the size of a printing medium 1201 is variable. Thus, at the left or right edge of the printing medium 1201, the patch 1007 may be printed with part thereof missing. In a case where part of the patch 1007 is missing and the patch 1007 is printed over the length of the detection mark 1019 or longer, for the left edge, the pattern 1008 for pattern matching corresponding to the rectangle 1010 is selected as a pattern for calculation. For the right edge, the pattern 1008 for pattern matching corresponding to the rectangle 1011 is selected as a pattern for calculation.

Depending on the printhead 102, as a patch for each printing element substrate 1002, the patch 1016 may be printed in addition to the patch 1007. The patch 1016 is designed to include a detection mark 1023, alignment marks 1024, and patterns for pattern matching 1017. The patterns for pattern matching 1017 are each printed by the plurality of nozzle arrays 1005. The letter P on patterns on a layout 1018 denotes that those patterns are printed by the plurality of nozzle arrays 1005. This patch 1016 is used to calculate the tilt of the printhead 102 that printed the patch 1016.

The patches 1007, 1016 for the printing element substrates 1002 are printed on a printing medium at timings shifted by amounts considering tolerance of manufacturing error in the nozzle arrays 1005 and manufacturing error in the printing element substrates 1002, so that test charts may not overlap due to error.

The detection marks 1019, 1023 are used to detect the patches 1007, 1016 for the printing element substrates 1002 on a scan image through image analysis processing. Each detection mark 1019, 1023 is a pattern printed in the shape of a rectangular region.

In the present embodiment, each detection mark 1019, 1023 is printed by droplets ejected by the plurality of nozzle arrays 1005. The detection marks 1019, 1023 are printed using the plurality of nozzle arrays 1005 because even in a case where a particular nozzle array 1005 has a non-ejecting nozzle, the detection pattern is less likely to have a missing portion due to the non-ejecting nozzle because nozzles in the other nozzle arrays 1005 eject droplets. Thus, the detection marks 1019, 1023 can be detected stably by image analysis processing.

The alignment mark 1020, 1024 is used to calculate a reference position for an analysis region of the pattern 1008 for pattern matching, 1017 through image analysis processing. Each alignment mark 1020, 1024 is printed in the shape of a rectangular region. The alignment mark 1020, 1024 is printed by droplets ejected from the plurality of nozzle arrays 1005 and is printed for each of the patterns 1008 for pattern matching, 1017 for the respective nozzle arrays 1005.

The patterns 1008 for pattern matching, 1017 are also used to detect a positional shift of each printhead 102 through image analysis processing, and either the patches 1007 or the patches 1016 are selectively used depending on the ink color of the printhead 102 or the type of a shift amount to calculate.

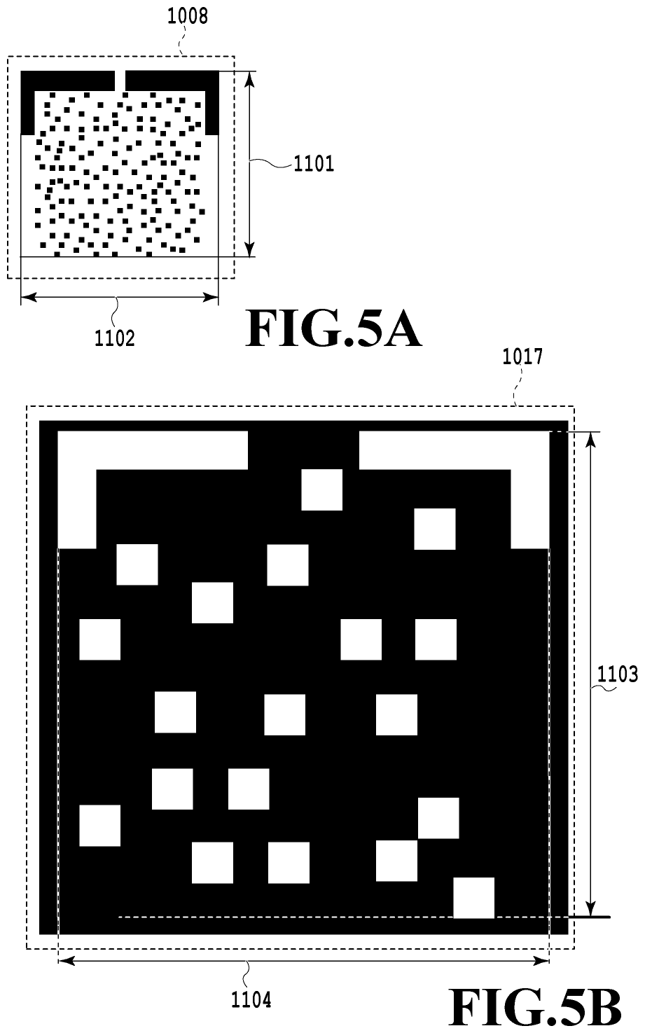

FIG. 5A is a diagram showing a detailed layout of the pattern 1008 for pattern matching, and FIG. 5B is a diagram showing a detailed layout of the pattern for pattern matching 1017. A distance 1101 corresponds to the number of pixels in the longitudinal direction of the pattern 1008 for pattern matching, and a distance 1102 corresponds to the number of pixels in the lateral direction of the pattern 1008 for pattern matching. A distance 1103 corresponds to the number of pixels in the longitudinal direction of the pattern for pattern matching 1017, and a distance 1104 corresponds to the number of pixels in the lateral direction of the pattern for pattern matching 1017.

In the present embodiment, on the pattern 1008 for pattern matching, the direction of the distance 1101 is parallel to the conveyance direction 201, and the direction of the distance 1102 is parallel to the nozzle array direction 1001, both of the distances 1101, 1102 corresponding to 82 pixels at 1200 dpi. Also, on the pattern for pattern matching 1017, the direction of the distance 1103 is parallel to the conveyance direction 201, and the direction of the distance 1104 is parallel to the nozzle array direction 1001, both of the distances 1103, 1104 corresponding to 210 pixels at 1200 dpi. Note that the number of pixels forming each pattern for pattern matching is not limited to the above, and they may have different numbers of pixels.

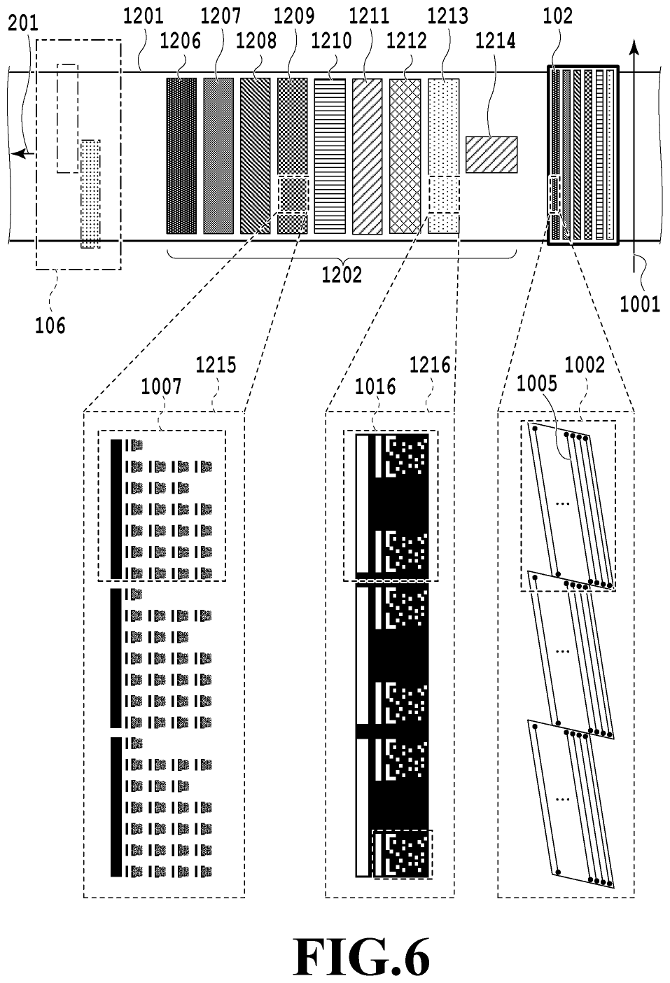

FIG. 6 is a diagram illustrating test charts used for calculating amounts of positional shift between nozzle arrays, between printing element substrates, and between printheads. In FIG. 6, test charts 1202 are printed by the printheads 102 on the printing medium 1201 which is roll paper. The test charts 1202 include test charts 1206 to 1213 used to calculate amounts of positional shift between the nozzle arrays 1005 and between the printing element substrates 1002 as well as amounts of tilt of the printheads 102. A test chart 1214 is a test chart for calculating amounts of positional shift between the printheads 102. As shown in FIG. 4, the nozzle array direction 1001 represents the direction in which the nozzles are arrayed on the printhead 102.

As shown in FIG. 1, the inkjet printing apparatus 100 includes a plurality of printheads 102. The printheads 102 support eight colors which are, from the upstream side in the conveyance direction of the printing medium 1201, Pr (liquid primer), K (black), C (cyan), M (magenta), Y (yellow), O (orange), V (violet), and G (green). The order of the colors of the printheads 102 may be changed. A printhead for a different color may be added or replace one of the above.

The scanner device 106 is disposed downstream of the printheads 102 in the conveyance direction of the printing medium 1201. The scanner device 106 scans the test charts 1202 printed on the printing medium 1201 to detect amounts of positional shift of the printheads 102.

The types of head position shift are described. All the types are attributable to error in formation of the printing element substrates 1002 or their nozzles on the printhead 102, error in installation of the printhead 102, or the like. Types of shift include inter-array shift between the nozzle arrays 1005 on the printing element substrate 1002, positional shift between the printing element substrates 1002 on the printhead 102, inter-color shift between the printheads 102, and the like. With such shifts, the ejection positions of ink droplets are deviated from ideal positions, which degrades the quality of an image printed. Head position shift correction is a function to correct the ejection positions of ink droplets by changing the timing of ink ejection from the printing element substrates 1002 or changing the nozzles to use for ejection.

In the present embodiment, a positional shift in a direction orthogonal to the nozzle array direction 1001 (i.e., in the conveyance direction 201) is corrected by changing the ejection timings of the printing element substrates 1002 forming the printhead 102. A positional shift in the nozzle array direction 1001 is corrected by changing ejection data. A positional shift due to a tilt of the printhead 102 is corrected by a combination of changing the ejection timings and changing ejection data.

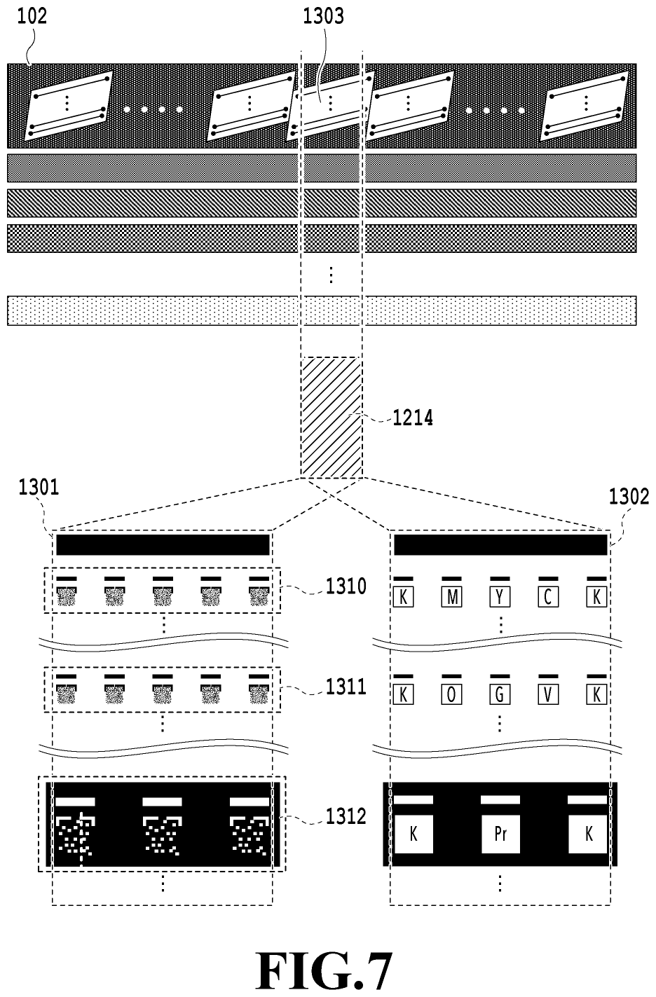

The test charts 1202 shown in FIG. 6 are test charts for correcting head position shifts of the printheads 102. The test charts 1206 to 1214 are test charts used for the eight heads, and each test chart is used to detect amounts of positional shift of a corresponding one of the printheads 102. These test charts 1206 to 1214 are used to calculate amounts of positional shift between the nozzle arrays 1005 on each printing element substrate 1002, amounts of positional shift between the printing element substrates 1002 on each printhead 102, and amounts of tilt of the printheads 102. In the present embodiment, each of the test charts 1206 to 1213 corresponds to one of the printheads 102 for the colors O, G, V, K, C, M, Y, and Pr. The test charts for the printheads 102 included in the test charts 1202 may be decreased or increased in number from the ones for the eight heads or may be changed in order. Thus, the number of test charts may change depending on the number of printheads 102 to be tested. Also, the test chart 1214 is used to calculate amounts of inter-color shift between the printheads 102 and is printed using all the printheads 102. The test chart 1214 will be described later using FIG. 7.

In the present embodiment, a test chart 1215 is a close-up of part of the test chart 1209 for the ink color K. In the test chart 1215, regions in black are regions printed by the corresponding ink, and regions in white are regions of the background color of the printing medium 1201 and is not printed by ink. Also, for each printhead 102, the patches 1007 for the respective printing element substrates 1002 forming the printhead 102 are printed linearly, arranged side by side in parallel to the nozzle array direction 1001.

In the present embodiment, the test charts 1206 to 1208 and 1210 to 1212 for the ink colors O, G, V, C, M, and Y have the same design as the test chart 1209.

In the present embodiment, a test chart 1216 is a close-up of part of the test chart 1213 for liquid primer. The test chart 1216 is designed such that for the respective printing element substrates 1002, the patches 1016 shown in FIG. 4 are printed linearly, arranged side by side in parallel to the nozzle array direction 1001.

Note that the present invention is not limited to the example shown in FIG. 6, and correspondence relations between the test charts and ink colors according to the types of the printheads 102 may be changed.

FIG. 7 is a diagram showing a correspondence between the test chart 1214 used for calculation for correcting inter-color shift between the printheads 102 and the printing element substrates 1002. Test charts for some of the colors are omitted. A test chart 1301 is the test chart 1214 for calculating positional error between the printheads 102. On the test chart 1301, the patterns 1008 for pattern matching, 1017 are printed by the printheads 102 of the respective ink colors, as shown on a layout 1302. The printing element substrate 1002 to use to print the test chart 1301 is selected from each of the printheads 102, one at a time. The printing element substrates 1002 on the respective printheads 102 used to print the test chart 1301 are ones located at the same position as a printing element substrate 1303 in the nozzle array direction 1001. In other words, no matter which printhead 102 is used, the printing element substrate 1002 located at the same position as the printing element substrate 1303 in the nozzle array direction 1001 is used to print the patterns 1008 for pattern matching. In the test chart 1301, portions depicted in black are portions printed with the corresponding ink color, and portions depicted in white are portions of the paper white (background) of the printing medium 1201.

In the present embodiment, the patterns 1008 for pattern matching are used for the colored inks K, C, M, Y, O, G, and V. As shown on the layout 1302, the printhead 102 for the ink color K is used as a reference head and prints the patterns 1008 for pattern matching at both ends, and positional shifts of the printheads 102 for inks other than the ink color K are calculated. In a layout 1310, amounts of positional shift of the printheads 102 for the inks C, M, and Y can be calculated using the printhead 102 for the ink color K as a reference head. In a layout 1311, amounts of positional shift of the printheads 102 for the inks O, G, and V can be calculated using the printhead 102 for the ink color K as a reference head. The layout 1310 and the layout 1311 are each printed a plurality of times, so that positional shift of the printheads 102 for the respective inks can be calculated a plurality of times. The average value of the positional shifts obtained by the plurality of calculations is used as a positional shift of each printhead 102 to diminish the influence of error in positional shift due to printing timing and to obtain more accurate positional shift. How many times to print the layout 1310 and the layout 1311 is determined according to demanded accuracy of positional shift calculation and may be once. FIG. 7 omits the repetitions of the layout 1310 and the layout 1311.

In the present embodiment, the patterns for pattern matching 1017 are used to calculate the positional shift of the printhead 102 for liquid primer. As shown in the layout 1302, the positional shift of the printhead 102 for liquid primer is calculated using the printhead 102 for the ink color K as a reference head. A layout 1312 is printed a plurality of times to be able to calculate positional shift of the printhead 102 for liquid primer a plurality of times, as with the colored inks. How many times to print the layout 1312 is determined according to demanded accuracy of positional shift calculation and may be once. FIG. 7 omits the repetitions of the layout 1312.

Patterns for pattern matching used for the reference head are the same as those for the printheads 102 for which to calculate shift. Also, the patterns for pattern matching for the colors are not limited to the ones shown in FIG. 5A, 5B, and 7, and different patterns may be used.

The test chart 1301 used to calculate the inter-color shift between the printheads 102 is printed with its timing to be printed on the printing medium 1201 being shifted a certain amount which exceeds the maximum amount of inter-color shift between the printheads 102. The printheads 102 print at timings shifted in this way so that there will be no overlap between the test charts.

### (Calculation of Amounts of Positional Shift Between Nozzle Arrays)

FIGS. 8A and 8B are diagrams showing how to calculate amounts of positional shift between nozzle arrays. As described above, in the present embodiment, a single printing element substrate 1002 has 16 nozzle arrays 1005 arranged thereon. Here, the first and the last nozzle arrays 1005 as counted from the downstream side in the conveyance direction 201 are denoted as R0 and R15, respectively.

The following describes how to calculate amounts of positional shift between the nozzle arrays 1005 using a scan image of the patch 1007 printed according to the layout 1012. In the layout 1012, a numerical value n (n>0) in each rectangle denotes the nozzle array 1005 used to print the pattern 1008 for pattern matching printed at that position. For instance, the numerical value “0” in a rectangle 1405 denotes that the pattern 1008 for pattern matching corresponding to the rectangle 1405 is printed using the R0-th nozzle array 1005. Hereinbelow, a rectangle showing a pattern for pattern matching printed by the Rn-th nozzle array 1005 and the printed position of the pattern is referred to as an “Rn pattern.”

As shown in FIG. 8A, the layout 1012 is divided into four regions 1401 to 1404. In the region 1401, R0 patterns 1405, 1406 are used as a reference. Similarly, in the regions 1402 to 1404, R0 patterns 1407 and 1408, R0 patterns 1409 and 1410, and R0 patterns 1411 and 1412 are used as a reference, respectively. In each of the regions 1401 to 1404, amounts of positional shift of the patterns for pattern matching (R1 to R15 patterns) printed by the other nozzle arrays 1005 are calculated in reference to the two R0 patterns.

FIG. 8B is used to describe an example of how to calculate an amount of positional shift between the R0-th nozzle array 1005 and the R9-th nozzle array 1005. An R0 pattern 1414 and an R0 pattern 1415 are patterns for pattern matching used as a reference, with the R0 pattern 1414 corresponding to the R0 pattern 1405 in the region 1401 and the R0 pattern 1415 corresponding to the R0 pattern 1406 in the region 1401. An R9 pattern 1416 is an R9 pattern printed in the region 1401. In a case where the patterns for pattern matching are printed by the R0-th nozzle array 1005 and the R9-th nozzle array 1005, the R9 pattern should be printed on a straight line connecting the R0 pattern 1414 and the R0 pattern 1415 unless there is positional shift of landing of ink ejected. An R9 pattern 1418 shows an R9 pattern printed at an ideal position without positional shift of landing, whereas the R9 pattern 1416 shows the actual print position of the R9 pattern.

An amount of positional shift between the R9 pattern 1416 and the R9 pattern 1418 is an amount of positional shift of the R9-th nozzle array 1005 relative to the R0-th nozzle array 1005. A lateral component of this amount of positional shift is an amount of positional shift 1417, and a longitudinal component thereof is an amount of positional shift 1419. The amount of positional shift 1419 is the length of a perpendicular to the straight line connecting the R0 pattern 1414 and the R0 pattern 1415, drawn from the R9 pattern 1416. Thus, the amount of positional shift 1419 can be calculated from the positions of the R0 pattern 1414, the R0 pattern 1415, and the R9 pattern 1416. Similarly, the amount of positional shift 1417 can be found based on these positions.

Using the method described above, amounts of positional shift of the R1 to R15 patterns can be calculated in reference to the R0 patterns to find amounts of positional shift of the R1-th to R15-th nozzle arrays 1005 relative to the R0 patterns.

(Calculating Amounts of positional shift between Printing Element Substrates)

FIGS. 9A and 9B are diagrams illustrating how to calculate amounts of positional shift between the printing element substrates 1002. In the present embodiment, as counted from the left side on the paper plane in FIG. 9A in the nozzle array direction 1001, the first printing element substrate 1002 is denoted as C0, and the last printing element substrate 1002 is denoted as C16. FIGS. 9A and 9B are used to describe how to calculate amounts of positional shift between the printing element substrates 1002 using a scan image of the patches 1007 printed according to the layout 1012 of the patches 1007.

Patches 1501 to 1503 shown in FIG. 9A schematically show patches 1007 printed by three different printing element substrates 1002 on the same printhead 102 according to the layout 1012 shown in FIG. 4. Depending on the size of the printing medium 1201 and conveyance error, there may be some printing element substrates 1002 that do not print the patch 1007 on the printing medium 1201. Hereinafter, a patch printed on the printing medium 1201 by a printing element substrate 1002 is referred to as a “Cn patch,” Cn being n>0 and denoting one of the plurality of printing element substrates 1002 on one of the printheads 102.

The patch 1501 is, out of the plurality of patches 1007 printed by a single printhead 102, the patch 1007 printed by the C1-th printing element substrate 1002, which is the printing element substrate 1002 on the right side of the leftmost one. Depending on the size of the printing medium 1201 and the like, the printing element substrate 1002 to print the patch 1501 varies. In the present embodiment, the patch 1501 is a C1 patch. The patch 1502 is, out of the plurality of patches 1007 printed by the printhead 102 that printed the C1 patch, the patch 1007 printed by the C15-th printing element substrate 1002, which is the printing element substrate 1002 on the left side of the rightmost one. In the present embodiment, the patch 1502 is a C15 patch. The patch 1503 is, out of the plurality of patches 1007 printed by the printhead 102 that printed the C1 and C15 patches, the patch 1007 printed by the printing element substrate 1002 for which to calculate an amount of positional shift between the printing element substrates 1002. Here, the C8-th printing element substrate 1002 located at the center of the printhead 102 is described as an example.

A coordinate point 1507 shown in FIG. 9B is, on the patch 1501 (the C1 patch), a middle point of a line segment connecting two R0 patterns in an array of the patterns 1008 for pattern matching arranged side by side in the nozzle array direction 1001 and is a representative position of the C1 patch. A coordinate point 1508 is, on the patch 1502 (the C15 patch), a middle point of a line segment connecting two R0 patterns in an array of the patterns 1008 for pattern matching arranged side by side in the nozzle array direction 1001 and is a representative position of the C15 patch. The printing element substrates 1002 that printed these C1 and C15 patches are used as a reference in calculating amounts of positional shift between the printing element substrates 1002. A coordinate point 1511 is, on the patch 1503 (the C8 patch), a middle point of a line segment connecting two R0 patterns in an array of the patterns 1008 for pattern matching arranged side by side in the nozzle array direction 1001 and is a representative position of the C8 patch. The C8-th printing element substrate 1002 is the target for which to calculate an amount of positional shift between the printing element substrates 1002.

For calculation of an amount of positional shift between the printing element substrates 1002, first, a case is considered where there is no positional shift of landing in printing of the patches 1007 at the representative positions of the C1, C8, and C15 patches. In this case, a coordinate point 1512 is the reference position of the C8 patch printed at the ideal position on a straight line connecting the coordinate point 1507 and the coordinate point 1508 without any positional shift of landing of ejected ink, i.e., the middle point of a line segment connecting the coordinate point 1507 and the coordinate point 1508. The coordinate point 1511, on the other hand, is the actual representative position calculated from the C8 patch on a scan image. An amount of positional shift between the coordinate point 1511 and the coordinate point 1512 includes a component parallel to and a component perpendicular to the reference line connecting the coordinate point 1507 and the coordinate point 1508. The component parallel to the reference line is a distance between the reference line and the actual representative position of the C8 patch and is referred to as an amount of positional shift 1514. The amount of positional shift 1514 is the length of a perpendicular to the reference line, drawn from the coordinate point 1511. Thus, the amount of positional shift 1514 can be found from the coordinate point 1507, the coordinate point 1508, and the coordinate point 1511. Also, the component perpendicular to the reference line is a distance between a line passing through the coordinate point 1511 and orthogonal to the reference line and a line passing through the coordinate point 1512 and orthogonal to the reference line and is referred to as an amount of positional shift 1513. Thus, the amount of positional shift 1513 can be found from the coordinate point 1507, the coordinate point 1508, the coordinate point 1511, and the coordinate point 1512.

Using the method described above, two printing element substrates 1002 are used as a reference, and amounts of positional shift of the other printing element substrates 1002 in between the reference printing element substrates 1002 can be found. However, a different method is used to calculate amounts of positional shift of the leftmost C0-th printing element substrate 1002 and the rightmost C16-th printing element substrate 1002 which are closer to the end portions than the two reference printing element substrates 1002 (the C1-th and C15-th printing element substrates 1002 in the example shown).

For instance, since the two reference printing element substrates 1002 are C1 on the left end side and C15 on the right end side, for the left end, the representative position of the C0 patch is the coordinate point 1511 to be adjusted, and for the right end, the representative position of the C16 patch is the coordinate point 1511 to be adjusted. The representative position of the C16 patch at the right end is, as with the other representative positions, the middle point of a line segment connecting two R0 patterns in an array of the patterns 1008 for pattern matching arranged side by side in the nozzle array direction 1001. The reference position of the C0 patch at the left end, on the other hand, is the position of the pattern for pattern matching corresponding to the rectangle 1011 printed by the C1-th printing element substrate 1002 which is on the right side of the C0-th printing element substrate 1002. This is because there is a possibility that the printing element substrate 1002 at the end portion can print only part of the layout 1012 on the printing medium 1201.

Depending on the length of the printing medium 1201 in the nozzle array direction 1001, the C0-th or C16-th printing element substrate 1002 may exist outside of the leftmost or rightmost printing element substrate 1002 located within a print area. In such a case, the C0-th or C16-th printing element substrate 1002 cannot print a patch on the printing medium 1201, and therefore the C0-th or C16th patch cannot be detected in its complete form. Thus, for the outside printing element substrate 1002 on the left side, an amount of positional shift for the printing element substrate 1002 which is on the right side thereof is used as a value for correction. Similarly, for the outside printing element substrate 1002 on the right side, an amount of positional shift for the printing element substrate 1002 which is on the left side thereof is used as a value for correction.

### (Calculating an Amount of Tilt of the Printhead)

FIGS. 10A to 10C are used to describe how to calculate an amount of tilt of the printhead 102 using a scan image of the patches 1007 printed according to the layout 1012. The calculation of an amount of tilt of the printhead 102 uses the same patches 1007 as the patches used to calculate amounts of positional shift between the printing element substrates 1002. Also, a tilt correction amount for the printhead 102 is an amount of positional shift from the average tilt of all the printheads and is calculated for all the printheads.

The patches 1501, 1502 shown in FIG. 10A are C1 and C15 patches printed by the same printhead 102. A patch 1504 and a patch 1505 shown in FIG. 10B are C1 and C15 patches printed by the same printhead 102 which is different from the printhead 102 that printed the patch 1501 and the patch 1502. As with the patch 1501 and the patch 1502, a coordinate point 1509, which is a representative position of the C1 patch, and a coordinate point 1510, which is a representative position of the C15 patch, are obtained from the patch 1504 and the patch 1505, respectively.

FIG. 10C is a diagram illustrating how to calculate an amount of tilt of the printhead 102. First, amounts of tilt of the respective printheads 102 are calculated. The coordinate point 1507 and the coordinate point 1508 are the representative positions of the patch 1501 (the C1 patch) and the patch 1502 (the C15 patch) printed by the reference printing element substrates 1002 on a printhead 102A which are the second ones from the leftmost and rightmost ones, respectively, as counted inward. An angle 1516 is an angle (a minor angle) formed by a line segment connecting the coordinate point 1507 and the coordinate point 1508 and an ideal line without positional shift of landing due to a tilt of the printhead 102A and indicates an amount of tilt of the printhead 102A.

Similarly, an amount of tilt of a printhead 102B is calculated. The coordinate point 1509 and the coordinate point 1510 are the representative positions of the C1 patch and the C15 patch printed by the above-described reference printing element substrates 1002 close to the left and right end portions of the printhead 102B. An angle 1517 is an angle (a minor angle) formed by a line segment connecting the coordinate point 1509 and the coordinate point 1510 and an ideal line without positional shift of landing due to a tilt of the printhead 102B and indicates an amount of tilt of the printhead 102B. Although not shown, an amount of tilt is obtained for all the other printheads 102 as well.

Lastly, a tilt correction amount is calculated for each printhead 102. A tilt correction amount based on an amount of relative tilt of each printhead 102 can be calculated using the formula below. An amount of tilt of the printhead 102 is expressed in an angle.

(A tilt correction amount for a printhead 102)=(the average tilt of all the printheads 102)−(the tilt of the printhead 102)

In a case where an angle 1518 shown in FIG. 10B is the average tilt of all the printheads 102, the tilt correction amount for the printhead 102A is, for example, a value obtained by subtracting the angle 1516 from the angle 1518.

Using the method described above, a tilt correction amount for each printhead 102 can be found based on the average tilt of all the printheads 102.

(Calculating Amounts of positional shift between the Printheads)

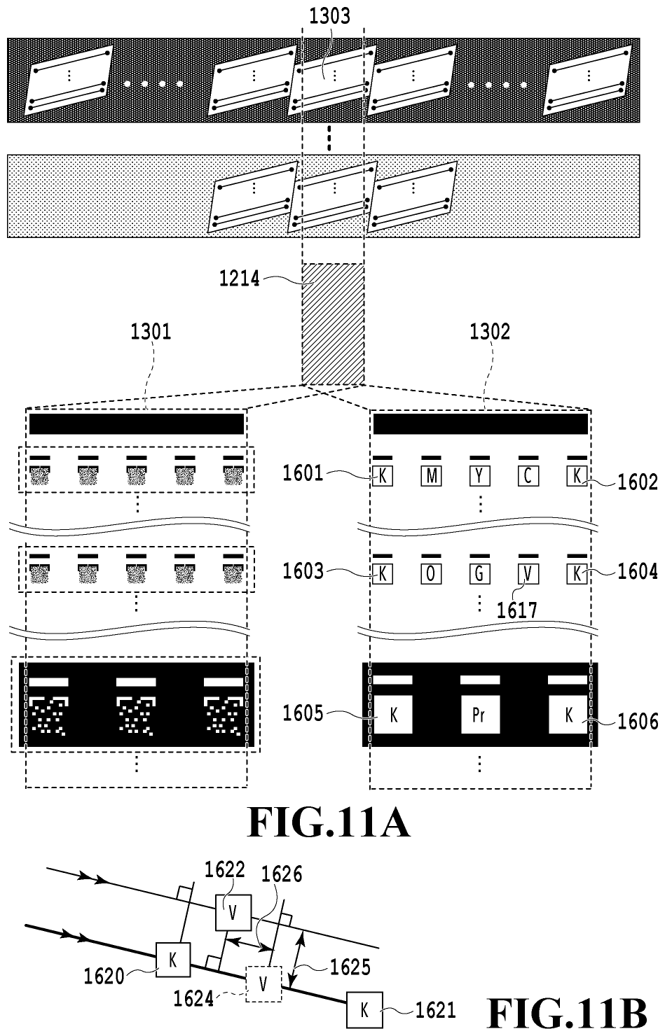

FIGS. 11A and 11B are diagrams illustrating how to calculate amounts of positional shift between the printheads 102. In the present embodiment, the first printhead 102 as counted from the upstream side in the conveyance direction 201 is a printhead Pr used for liquid primer. The printheads 102 after that are referred to as a printhead K, a printhead C, a printhead M, a printhead Y, a printhead O, a printhead V, and a printhead G for the colors of colored inks used. The following describes how to calculate amounts of positional shift between the printheads 102 (hereinafter referred to as “inter-color shift) using scan images of the test chart 1301 printed using the printheads 102 for the plurality of ink colors according to the layout 1302.

The test chart 1301 shown in FIG. 11A is the test chart 1214 used to calculate amounts of inter-color shift. The test chart 1301 is printed using the printing element substrates 1303 at a predetermined location on the printheads 102 of the predetermined colors as indicated in the layout 1302. In the present embodiment, the C8-th printing element substrates 1002 are used as the printing element substrates 1303 at the predetermined position. In the present embodiment, patterns for pattern matching 1601 to 1606 are patterns printed by the C8-th printing element substrate 1303 on the printhead K serving as the reference head (they are hereinafter referred to as K patterns). The other patterns having letters representing other ink colors are patterns printed by the printheads 102 for which to calculate positional shift between the printheads 102. Although these patterns are referred to as patterns for C, M, Y, O, V, G, and Pr (hereinafter referred to as C and other patterns) in the present embodiment, the number of ink colors may be increased or decreased. In the present embodiment, C, M, Y, O, V, and G patterns are printed using the design of the pattern 1008 for pattern matching shown in FIG. 5A. The K patterns 1601 to 1604 to serve as a reference for them are also printed using the design of the pattern 1008 for pattern matching. By contrast, in the present embodiment, the pattern for Pr (hereinafter referred to as a Pr pattern) is printed using the design of the pattern for pattern matching 1017 shown in FIG. 5B. The K patterns 1605, 1606 to serve as a reference for them are also printed using the design of the pattern for pattern matching 1017.

In the present embodiment, in calculation of amounts of positional shift between the printhead K (the reference head) and the printheads 102 for ink colors other than K, the same method is used for each printhead 102. Here, an example of how to calculate an amount of positional shift between the printhead K and the printhead V is described. A K pattern 1620 shown in FIG. 11B corresponds to the K pattern 1603, and a K pattern 1621 corresponds to the pattern 1604. These are patterns for pattern matching printed by the C8-th printing element substrate 1002 on the printhead K serving as a reference. A V pattern 1622 corresponds to a V pattern 1617, is a pattern for pattern matching printed by the C8-th printing element substrate 1002 on the printhead V, and is a pattern for pattern matching printed by the printhead 102 for which to calculate an amount of positional shift.

Without positional shift of landing of ejected ink, the V pattern printed by the printhead V should be printed on a reference line connecting the K pattern 1620 and the K pattern 1621. A V pattern 1624 is the position of the V pattern printed at an ideal position without any positional shift of landing of ejected ink. By contrast, the V pattern 1622 is the actual position of the V pattern.

In the present embodiment, an amount of positional shift on a scan image between the V pattern 1622 and the V pattern 1624 at the ideal position includes a component parallel to the reference line and a component perpendicular to the reference line. An amount of positional shift 1625 is a component perpendicular to the reference line, of the amount of positional shift between the V patterns 1622 and 1624. This amount of positional shift 1625 is the length of a perpendicular to the reference line, drawn from the V pattern 1622. Thus, the amount of positional shift 1625 can be found based on the positions of the K pattern 1620, the K pattern 1621, and the V pattern 1622. An amount of positional shift 1626 is a component parallel to the reference line, of the amount of positional shift between the V patterns 1622 and 1624. This amount of positional shift 1626 is the distance between a line passing through the V pattern 1622 and being orthogonal to the reference line and a line passing through the V pattern 1624 and being orthogonal to the reference line. Thus, the amount of positional shift 1626 can be found based on the positions of the K pattern 1620, the K pattern 1621, the V pattern 1622, and the V pattern 1624. In the head position shift correction of the present embodiment, a correction amount is calculated for both of the directions of the amount of positional shift 1625 and the amount of positional shift 1626.

Using the method shown above, an amount of inter-color shift between the printhead K serving as the reference head and each of the printheads 102 for ink colors other than K can be found.

### (Mark Detection Processing)

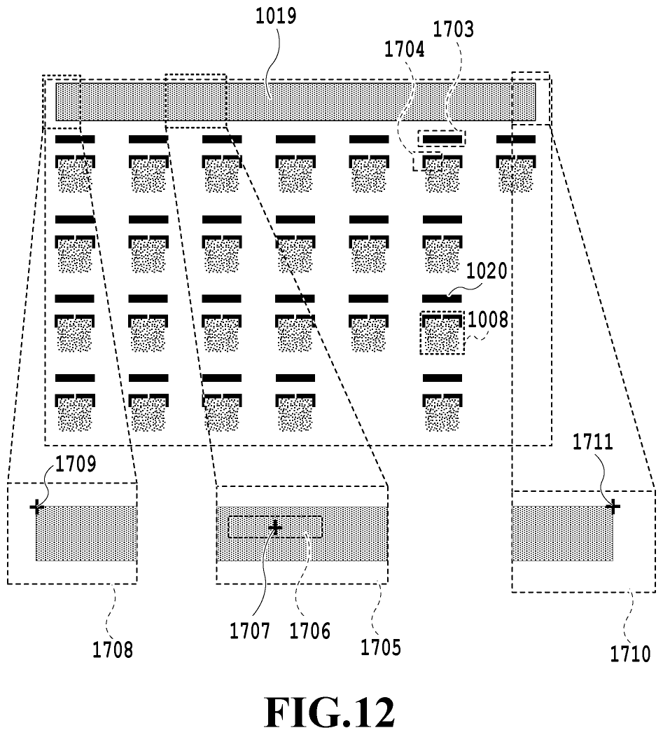

FIG. 12 is a diagram illustrating mark detection processing for the printing element substrate 1002. The following describes processing performed in the present embodiment to detect detection marks in the patches 1007 for the respective printing element substrates 1002 from a scan image of the test charts 1202 for positional amount calculation. FIG. 12 shows the patch for each printing element substrate 1002, the patch being equivalent to the patch 1007 shown in FIG. 4. Although there are two types of patches for the printing element substrates 1002 in the present embodiment, namely the patches 1007, 1016 in FIG. 4, the detection processing is performed in the same manner for both of them. Also, the same detection processing is performed for the test chart 1301 shown in FIG. 7 used to calculate positional error between the printheads 102. In the description below, the patch 1007 shown in FIG. 4 is used as an example.

The mark detection processing roughly has three steps. In the first step, the detection mark 1019 is detected, and based on the detected position of the detection mark 1019, the position of the patch 1007 for a single printing element substrate 1002 is estimated. In the second step, based on the position of the patch 1007 estimated in the first step, an alignment mark 1703 for estimating the position of the pattern 1008 for pattern matching is detected. The alignment mark 1703 is a mark similar to the alignment mark 1020 on the patch 1007 shown in FIG. 4. Because this alignment mark 1703 is printed near each pattern 1008 for pattern matching, the position of the corresponding pattern 1008 for pattern matching is estimated from the detected position of the alignment mark 1703. In the third step, pattern position detection is performed using pattern matching, based on the position of the pattern 1008 for pattern matching estimated in the second step.

The processing for detecting the detection mark 1019 in the first step is described. This processing uses, among the three channels RGB on a scan image that can be scanned by the scanner device 106, the luminance value of the channel with the highest density of the ink color of the printhead 102 for the pattern to be detected. For instance, the R-channel has the highest density for C (cyan); the G-channel has the highest density for M (magenta), and the B-channel has the highest density for Y (yellow). Note that in a case of an ink color having high density in all the channels like K (black), any of the channels is selected and used.

Reference numeral 1705 shows a close-up of part of the detection mark 1019. The detection mark 1019 is detected based on the average density of a predetermined region on a scan image. A detection mark detection region 1706 is the region from which to obtain the average density. In a case where the average density obtained in the detection mark detection region 1706 is a predetermined density or above, that region is identified as a detection mark region, and the center position thereof is set as a detection mark detection position 1707. The area of the detection mark detection region 1706 and the predetermined density used as a threshold may be changed.

Next, the positions of the upper left corner and the upper right corner of the detection mark 1019 are detected. Reference numeral 1708 is a close-up view of an area around the upper left corner of the detection mark 1019, and reference numeral 1710 is a close-up view of an area around the upper right corner of the detection mark 1019. A region with the predetermined density or above is scanned from the detection mark detection position 1707, and the upper left corner of the region with the predetermined density or above is set as a detection mark's upper left corner position 1709. Similarly, the upper right corner of the region with the predetermined density or above is set as a detection mark's upper right corner position 1711. The density barycenter of the predetermined region is calculated using, as a start point, a position determined based on the detection mark's upper left corner position 1709, and a detection range for the alignment mark 1703 is thereby estimated. Detection of the detection mark 1019 enables estimation of the detection range for the alignment mark 1703. As with the detection processing for the detection mark 1019, the detection processing for the alignment mark 1703 is performed as follows: a region with a predetermined density or above is scanned, a density barycenter of the region is calculated, and the position of the alignment mark 1703 is thereby detected.

Next, the positions of the patterns 1008 for pattern matching are estimated. A region 1704 is a region showing the position of the upper left corner of the pattern 1008 for pattern matching. The detection result of the detection mark 1019 is used in determining the printing element substrate 1002 and the printhead 102 to which this pattern 1008 for pattern matching belongs. After rough positions of the patterns 1008 for pattern matching are estimated by the above processing, position detection processing including pattern matching processing is performed to detect their final positions on the scan image. These positions of the patterns 1008 for pattern matching on the scan image are used to calculate distances used in calculating various amounts of positional shift for the head position shift correction. The various amounts of positional shift include manufacturing error between the nozzle arrays 1005, manufacturing error between the printing element substrates 1002, tilts of the printheads 102, and positional shift between the printheads 102.

### (Scan Images Obtained by a Plurality of Sensors)

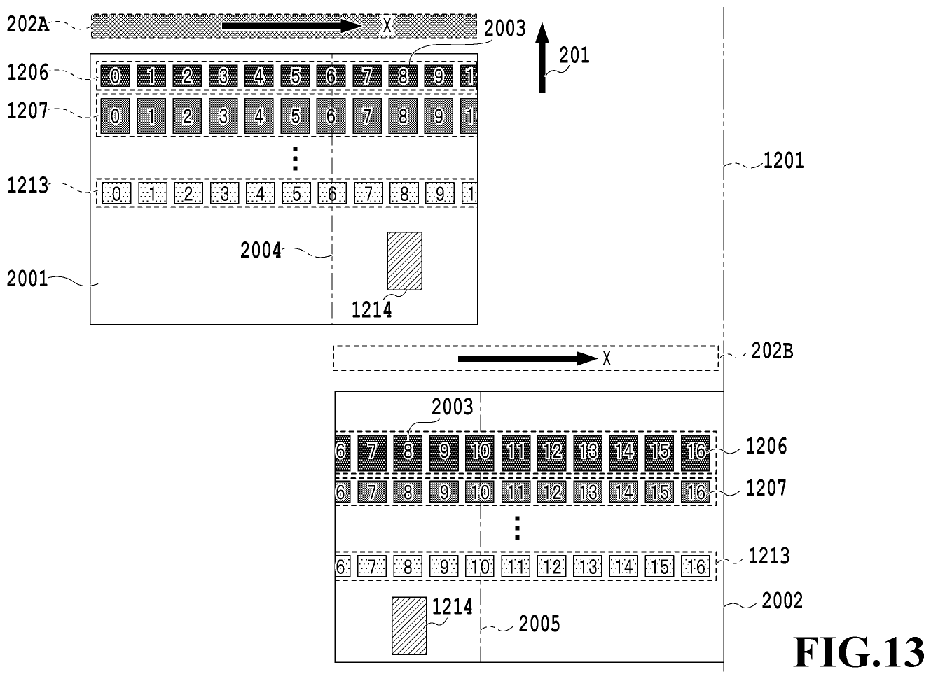

FIG. 13 is example scan images of the test charts 1202, obtained by the two sensors 202A, 202B in the scanner device 106 with the printing medium 1201 being conveyed in the conveyance direction 201. A scan image 2001 and a scan image 2002 have test charts scanned respectively by the sensor 202A and the sensor 202B, which are CCD line sensors, and are schematically depicted. In a case where the width of the printing medium 1201 extends over both of the region captured by the sensor 202A and the region captured by the sensor 202B, a scan image of the test charts 1202 is formed by a scan image obtained by the sensor 202A and a scan image obtained by the sensor 202B.

The following describes how scan images are obtained using the scanner device 106. Light from a lamp (not shown) in the scanner device 106 hits and gets reflected by the print surface of the printing medium 1201, and the reflected light passes through a lens and focuses onto the sensor 202A or 202B. Receiving this reflected light, each sensor 202 outputs an analog signal having an intensity in accordance with the amount of the light, and the signal outputted from each sensor 202 is converted into a digital signal by the scanner control unit 411. In this way, first, the CCD line sensors scan a line of the printing medium 1201, the line extending over the sensor line direction (the direction indicated by arrow X in FIG. 13). This line scanning is repeated while the printing medium is moved in the printing medium conveyance direction 201 which intersects with (or is ideally orthogonal to) the sensor line direction X, thereby scanning all of the test charts 1202. The digital signals obtained by the scanning are accumulated to obtain scan images of all the test charts 1202 printed. Scan images of the test charts 1202 obtained this way are the scan images 2001, 2002, and in the present embodiment, amounts of positional shift of ink landing positions from their ideal positions are calculated based on these scan images.

In FIG. 13, in each scan image, the patches 1007 or 1016 for the respective printing element substrates 1002, which constitute test charts 1206, 1207, 1213, are depicted as rectangles having numbers n thereinside. Specifically, a rectangle having a number n thereinside indicates that it is a patch printed by the Cn-th printing element substrate 1002. For instance, a patch 2003 is a C8 patch for the printhead 102 for the colored ink O. FIG. 13 omits the test charts 1202 for some of the printheads 102, and a complete picture of the test charts 1202 changes depending on the number of printheads 102 or a combination of colors. Each scan image also has, below the C8 patch, the test chart 1214 for calculating inter-color shift between the printheads 102.

Disposed in a zigzag manner, the sensor 202A and the sensor 202B are spaced away from each other in the conveyance direction 201. During a scan, the conveyance speed of the printing medium 1201 may temporarily fluctuate due to a sporadic event such as paper flopping, peripheral airflow turbulence, or shaking of the apparatus. In such a case, scan data extends or contracts in the conveyance direction 201. In regards to this, because the sensor 202A and the sensor 202B are spaced away from each other in the conveyance direction, scan data obtained by the sensor 202A and scan data obtained by the sensor 202B differ in the area on the scan data where the extension or contraction occurs. Thus, even in a case where the same test charts are scanned, the test charts 1202 on the scan image obtained by the sensor 202A and the test charts 1202 on the scan image obtained by the sensor 202B are affected by the extension or contraction in different areas. In the example shown in FIG. 13, on the scan data obtained by the sensor 202A, the test chart 1207 is affected by the fluctuation in the conveyance speed and extends in the conveyance direction 201. By contrast, on the scan image obtained by the sensor 202B, the test chart 1206 is affected by the fluctuation in the conveyance speed and extends in the conveyance direction 201. In order to demonstrate the magnitude of the influence of the fluctuation in the conveyance direction, the following case is considered as an example: the conveyance speed of the printing medium is 20 m per minute, i.e., 333.33 mm per second, the scanning resolution is 600×600 dpi, and the length of the patches 1007 in the conveyance direction is 10.50 mm. In this case, in a case where the conveyance direction temporarily drops 5% to 316.66 mm per second, the length of the patches 1007 scanned during the fluctuation of the conveyance speed is 11.025 mm in the conveyance direction. An amount of change in the length of the patches 1007 before and after the fluctuation in the conveyance direction is 11.025-10.50=+0.525 (mm), and +12 pixels/600 dpi.

Because the sensor 202A and the sensor 202B are disposed in a zigzag manner, the scan images 2001, 2002 obtained by them have a region that are scanned by both of the sensors. This region is hereinafter referred to as an overlap region, and a region outside of the overlap region is referred to as a non-overlap region. The overlap region is a region 2004 on the scan image 2001 and a region 2005 on the scan image 2002. The width of the overlap region varies depending on how much the sensors overlap with each other, but in the present embodiment, it needs to be wide enough to include a pattern that can be used to calculate a rate of extension/contraction between the scan images. A pattern that can be used to calculate a rate of extension/contraction between the scan images is, like a pattern 2003 for example, a patch printed by a single printing element substrate 1002 on a single printhead 102. Details will be described later in regards to calculation of a rate of extension/contraction between the scan images using a patch located in the overlap region and its usage.

(Calculating Amounts of positional shift Based on the Test Charts Divided into a Plurality of Scan Images)

The following explains how to calculate amounts of positional shift between the nozzle arrays 1005, between the printing element substrates 1002, and between the printheads 102 as well as amounts of tilt of the printheads 102 from scan images in the present embodiment.

Positional shift of the printhead 102 is corrected as described earlier. However, in a case where the test charts 1202 are scanned by a plurality of sensors 202 and consequently divided and obtained in a plurality of scan images as shown in FIG. 13, this point needs to be taken into consideration. Particularly in calculation of amounts of positional shift between the printing element substrates 1002, an amount of positional shift of each of the printing element substrates 1002 in between the printing element substrates 1002 serving as a reference is found in relation to a reference line connecting the printing element substrates 1002 serving as the reference. Because the printing element substrates 1002 which are the second ones from the endmost ones as counted inward are used as the reference, C1 and C15 are used as the reference in the test charts 1202 shown in FIG. 13. However, in a case where the test charts 1202 are divided into a plurality of scan images as shown in FIG. 13, C1 is included only in the scan image 2001, and C15 is included only in the scan image 2002. In other words, each of the scan images includes only one of the patches for the printing element substrates 1002 serving as the reference. Thus, the reference line connecting the reference printing element substrates 1002 cannot be found only with one of the scan images, which makes it unable to calculate the various amounts of positional shift and tilt. For example, the reference line connecting the reference printing element substrates 1002 can be obtained by using the overlap regions and combining the two scan images 2001, 2002 into one image. However, the larger the scan images, the larger the volume of data of the scan images themselves, which increases CPU processing load and possibly decreases the speed for processing other than the scan image analysis as well. Also, combining the two scan images 2001, 2002 entails the need to perform processing for aligning the tiles of the sensors 202A, 202B and differences in color tone. Thus, it is more desirable to be able to calculate the various amounts of positional shift and tilt without combining the scan images 2001, 2002. Thus, the present embodiment does not combine the plurality of scan images 2001, 2002 obtained by the plurality of sensors 202A, 202B. Instead, the present embodiment multiplies positional information on the reference printing element substrate 1002 on the test chart 1202 on one of the scan images by a rate of extension/contraction corresponding thereto to make correction so that the distances between the same corresponding patterns may be equal to each other. Then, the reference line is found based on the corrected positional information and uncorrected positional information on the reference printing element substrate 1002 on the other one of the scan images. The reference line thus obtained is used to calculate amounts of positional shift between the nozzle arrays 1005, between the printing element substrates 1002, and between the printheads 102 as well as amounts of tilt of the printheads 102.

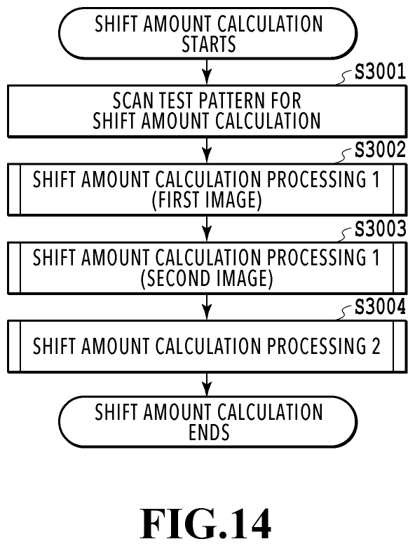

FIG. 14 is a flowchart of shift amount calculation in the present embodiment. The following explains the steps.

In S3001, the scanner device 106 scans the test charts 1202 printed on the printing medium 1201. In regards to the timing to start the scanning, the scanner device 106 may start scanning the test charts 1202 after a predetermined period of time elapses since the start of printing of the test charts 1202 or after the printing medium having all the test charts 1202 printed thereon is conveyed a predetermined amount. In regards to the timing to end the scanning, the scanner device 106 ends the scanning after scanning a predetermined number of lines since the start of the scanning.

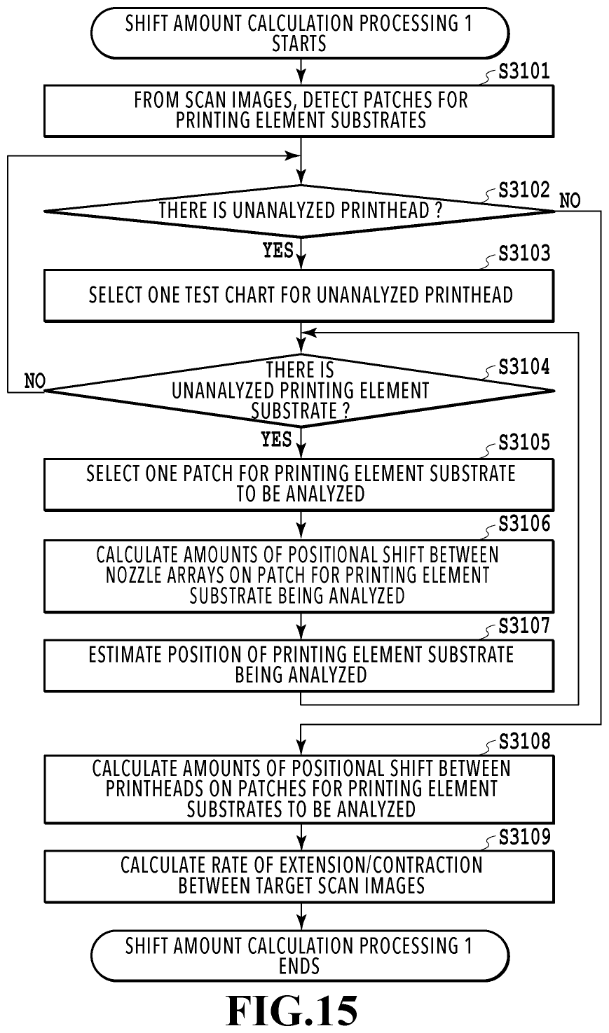

In S3002, the print controller 402 executes shift amount calculation processing 1 on the first scan image 2001, which is the scan image 2001 scanned by the sensor 202A in S3001. The shift amount calculation processing 1 is processing to calculate amounts of positional shift between the nozzle arrays 1005, amounts of positional shift between the printheads 102, and a rate of extension/contraction between the scan images and will be described in detail later using FIG. 15.

In S3003, the print controller 402 executes the shift amount calculation processing 1 on the second scan image 2002, which is the scan image 2002 scanned by the sensor 202B in S3001. The shift amount calculation processing 1 is the same processing as that executed in S3002.

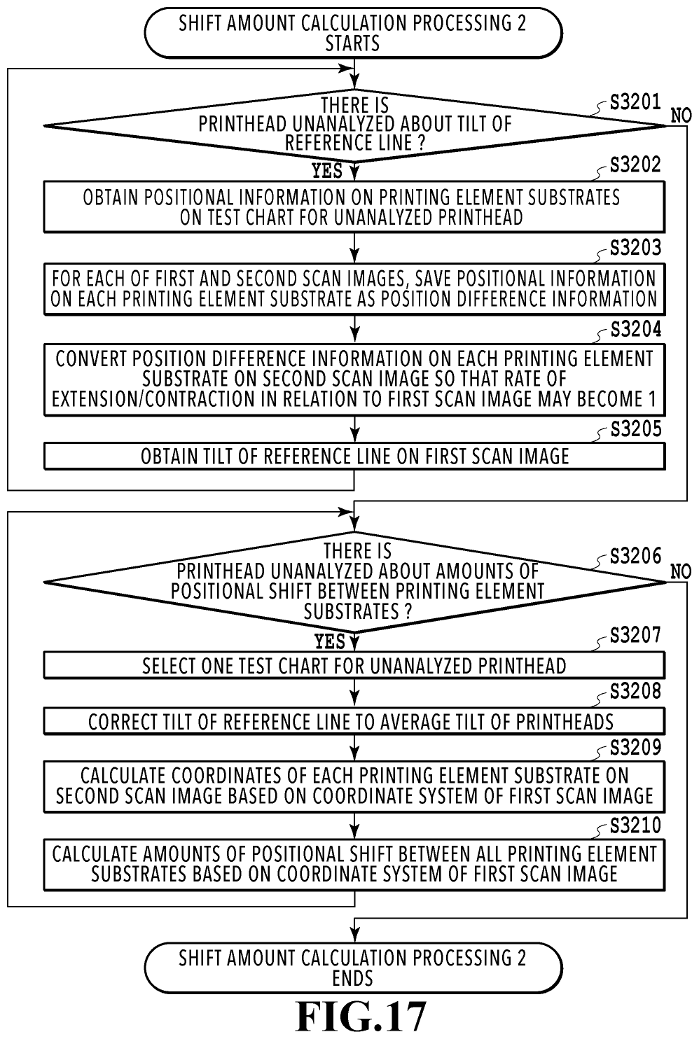

In S3004, the print controller 402 executes shift amount calculation processing 2 on the first scan image 2001 and the second scan image 2002. The shift amount calculation processing 2 is processing to calculate amounts of positional shift between the printing element substrates 1002 based on the reference line corrected based on the rate of extension/contraction between the scan images 2001, 2002 and an amount of tilt of the printhead 102 and will be described in detail later using FIG. 17.

Note that in an alternative embodiment, the steps of the shift amount calculation flowchart described above may be executed by the host device 500.

FIG. 15 is a flowchart of the shift amount calculation processing 1. FIG. 15 is used to explain the steps of the shift amount calculation processing 1.

In S3101, the print controller 402 detects patches for the respective printing element substrates 1002 from the first and second scan images of the test charts 1202 obtained in S3001. The method described using FIG. 12 can be used for the processing to detect the patches for the respective printing element substrates 1002.

In S3102, the print controller 402 determines whether there is any test chart corresponding to the printhead 102 unanalyzed about amounts of positional shift between the printing element substrates 1002 and amounts of positional shift between the nozzle arrays 1005. A test chart corresponding to the printhead 102 is any of the test charts 1206 to 1213 shown in FIGS. 6 and 13. If there is any test chart corresponding to an unanalyzed printhead 102, the processing proceeds to S3103, and if there is no test chart corresponding to an unanalyzed printhead 102, the processing proceeds to S3108.

In S3103, the print controller 402 sequentially selects one of the test charts corresponding to the printheads 102 unanalyzed about the various amounts of positional shift, for example from the test chart 1206.

In S3104, the print controller 402 determines whether the selected test chart has the patch 1007 or 1016 for the printing element substrate 1002 unanalyzed about amounts of positional shift between the nozzle arrays 1005. If there is any patch 1007 or 1016 for an unanalyzed printing element substrate 1002, the processing proceeds to S3105, and if there is no patch 1007 or 1016 for an unanalyzed printing element substrate 1002, the processing proceeds to S3102. The patches for the printing element substrate 1002 to be analyzed are the patches 1007 or 1016 for the respective printing element substrates 1002 on the scan images 2001, 2002 scanned in the S3101, and a patch located near the center of the overlap region is set as a border patch. In a case where the border patch is the C8 patch, patches to be analyzed are the C0 to C8 patches for the scan image 2001 and the C8 to C16 patches for the scan image 2002. The border patch 1007 or 1016 may be any patch as long as it is located in the overlap region, and may be the C7 patch or the C9 patch on the scan image 2001 and the scan image 2002.

In S3105, the print controller 402 sequentially selects one of the patches for the printing element substrates 1002 to be analyzed, for example from C0 in the case of the scan image 2001.

In S3106, using the scan image including the patch 1007 or 1016 for the printing element substrate 1002 selected to be analyzed, the print controller 402 calculates amounts of positional shift between the nozzle arrays 1005 on the target printing element substrate 1002. The method described using FIGS. 8A and 8B is used to calculate amounts of positional shift between the nozzle arrays 1005 in the present embodiment. If the patch selected to be analyzed is the patch 1007, analysis is performed, and if the patch selected to be analyzed is the patch 1016, analysis is skipped. For amounts of positional shift between the nozzle arrays on C8, which is analyzed on both of the scan image 2001 and the scan image 2002, calculation results obtained based on one of the scan images are used.

In S3107, the print controller 402 estimates the position of the printing element substrate 1002 being analyzed. The coordinates of the printing element substrate 1002 are, like the coordinate point 1507 described using FIGS. 9A and 10A, the middle point of a line segment connecting the two patterns 1008 for pattern matching printed using R0 of the printing element substrate 1002. For the position of the C8-th printing element substrate 1002 analyzed on both of the scan image 2001 and the scan image 2002, a position based on the coordinate system of the scan image 2001 and a position based on the coordinate system of the scan image 2002 are estimated separately. After S3107, the processing proceeds back to S3103 to set another unanalyzed printing element substrate 1002 as a printing element substrate 1002 to be analyzed and perform the processing in S3106 and S3107 on the patches for all the printing element substrates 1002 on the target printhead 102.

In S3108, the print controller 402 calculates amounts of positional shift between the printheads 102 using the test chart 1214 for measuring amounts of positional shift between the printheads 102 on the scan images 2001, 2002. In the present embodiment, amounts of positional shift between the printheads 102 are calculated as described using FIGS. 11A and 11B. The test chart 1214 is included in both of the scan image 2001 and the scan image 2002, and thus, for amounts of positional shift between the printheads 102, calculation results obtained on one of the scan images are used.

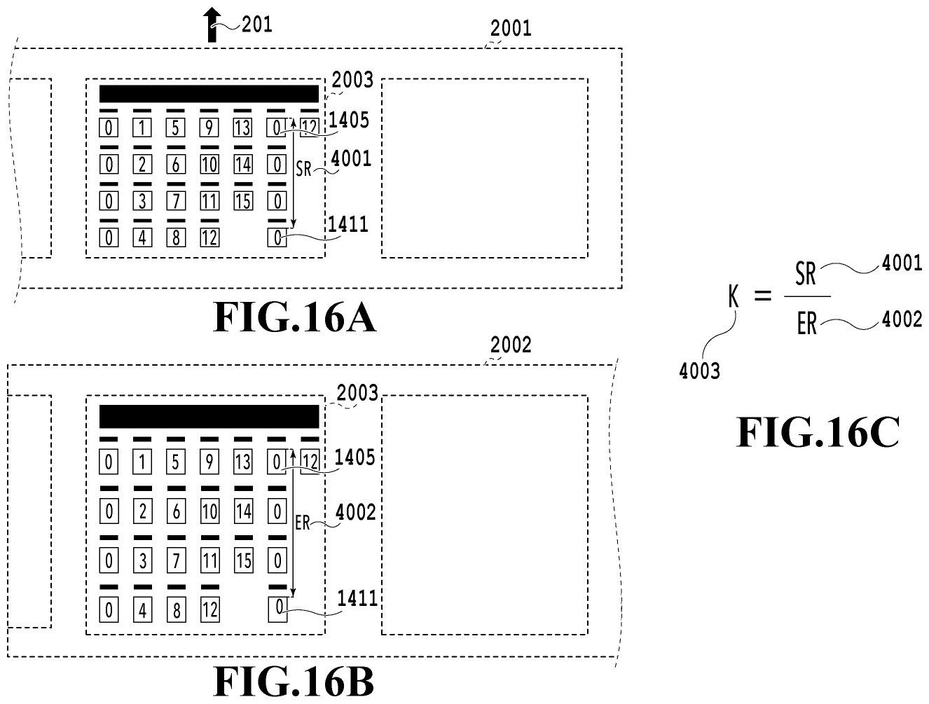

In S3109, the print controller 402 calculates, for each of the test charts 1202, a rate of extension/contraction of the patches 1007, 1016 for the printing element substrates 1002 between the scan images. FIGS. 16A to 16C are used to describe how to calculate the rate of extension/contraction of the patches 1007, 1016 for the printing element substrates 1002 between the scan images.

FIGS. 16A to 16C are diagrams illustrating a procedure for calculating, for each of the test charts 1202, a rate of extension/contraction of the patches 1007, 1016 for the printing element substrates 1002 between the scan images. FIG. 16A is a diagram showing details of the patch 2003 on the scan image 2001 shown in FIG. 13, and FIG. 16B is a diagram showing details of the patch 2003 on the scan image 2002 shown in FIG. 13. Because the scan image 2001 and the scan image 2002 are affected by the conveyance direction fluctuation at different locations from each other, the patch 2003 on the scan image 2001 and the patch 2003 on the scan image 2002 are different in how they are extended/contracted in the conveyance direction 201. This difference is found as follows.

The patch 2003 is a patch formed according to the layout 1012 shown in FIG. 4 and used to calculate amounts of positional shift between the nozzle arrays 1005 and is located in each of the overlap regions on the scan images 2001, 2002. A distance 4001 and a distance 4002 from the upper edge of the R0 pattern 1405 to the upper edge of the R0 pattern 1411 are found on the scan images 2001, 2002, respectively, the R0 patterns 1405 and 1411 being printed by the R0-th nozzle array 1005 and used as a reference in the calculation of amounts of positional shift between the nozzle arrays 1005. The distance 4001 and the distance 4002 are referred to as SR and ER, respectively. Then, the distance SR on the scan image 2001 is divided by the distance ER on the scan image 2002. In this way, as shown in FIG. 16C, a rate of extension/contraction 4003 of one of the test charts 1202 on the scan image 2001 in relation to the same corresponding test chart 1202 on the scan image 2002 can be calculated. This rate of extension/contraction 4003 is referred to as K. The following shows a formula for calculating K.

$$K = \frac{SR}{ER}$$

In a case where the following specific numerical values are applied as the distances before and after the fluctuation of the conveyance speed described above, the length of the distance SR before the fluctuation of the conveyance speed is 10.50 mm, and the length of the distance ER upon the fluctuation of the conveyance direction is 11.025 mm. Then, the rate of extension/contraction between them is 10.50/11.025=0.952.

Although SR<ER in the example shown in FIGS. 16A to 16C, they may be opposite in magnitude. Also, other two points on the patch 2003 may be used to obtain the lengths of the patches 2003 measured in the conveyance direction 201 on the scan images 2001, 2002 obtained by the sensors 202A, 202B. The above has described a procedure for finding the rate of extension/contraction of one of the test charts 1202 between the scan images obtained by the respective sensors by using the patches 2003, which are the C8 patches for the printhead 102 for the colored ink O. However, patches printed by the printhead 102 for a different ink color may be used as long as they are included in the overlap region of both of the scan images 2001, 2002 and can be used to calculate a distance in the conveyance direction 201. Also, patches for the printing element substrates 1002 different between the scan images 2001, 2002 may be used as long as they are included in the overlap region of both of the scan images 2001, 2002 and correspond to the printing element substrates 1002 included in the same printhead 102. Also, in a case where the scanner device includes three or more sensors and obtains three or more scan images, the rate of extension/contraction is found using the above-described method on a pair of scan images. In such a case, two scan images used as a pair of scan images are scan images obtained by two sensors adjacent to each other in the scanner device 106.

FIG. 17 is a flowchart of the shift amount calculation processing 2. FIG. 17 is used to explain the steps of the shift amount calculation processing 2.

In S3201, the print controller 402 determines whether the first scan image 2001 obtained by the sensor 202A has a test chart corresponding to the printhead 102 the tilt amount of which has yet to be calculated. If there is a test chart corresponding to the printhead 102 the tilt amount of which has yet to be calculated, the processing proceeds to S3202, and if there is no test chart corresponding to the printhead 102 the tilt amount of which has yet to be calculated, the processing proceeds to S3206. Processing in S3202 to S3205 is executed, setting the printhead 102 the tilt of which has yet to be calculated, as the printhead to be analyzed.

In S3202, the print controller 402 acquires positional information on each printing element substrate 1002 on the test chart corresponding to the printhead 102 the tilt amount of which has yet to be calculated. Positional information on each printing element substrate 1002 is the one estimated in S3107 on the first scan image 2001 obtained from the sensor 202A and the second scan image 2002 obtained from the sensor 202B.

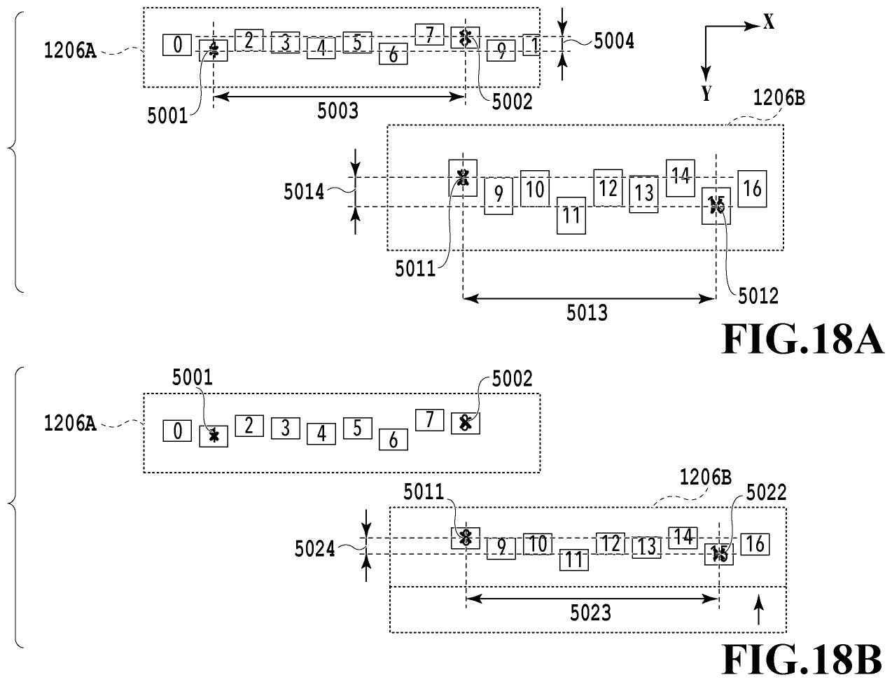

In S3203, the print controller 402 converts the representative positions of the patches 1007 for the respective printing element substrates 1002 on the first scan image 2001 and the second scan image 2002 into position difference information in relation to the origin located on the overlap region of each of the scan images. Details of S3203 will be described later using FIG. 18A.

In S3204, based on the position difference information for the second scan image 2002 and the rate of extension/contraction K, the print controller 402 converts the position difference information for the second scan image 2002 so that the rate of extension/contraction may become 1. Converting the position difference information so that the rate of extension/contraction may become 1 means converting the distance between particular patterns on the second scan image 2002 into a distance equal to the distance between the same corresponding particular patterns on the first scan image 2001. Details of S3204 will be described later using FIG. 18B.

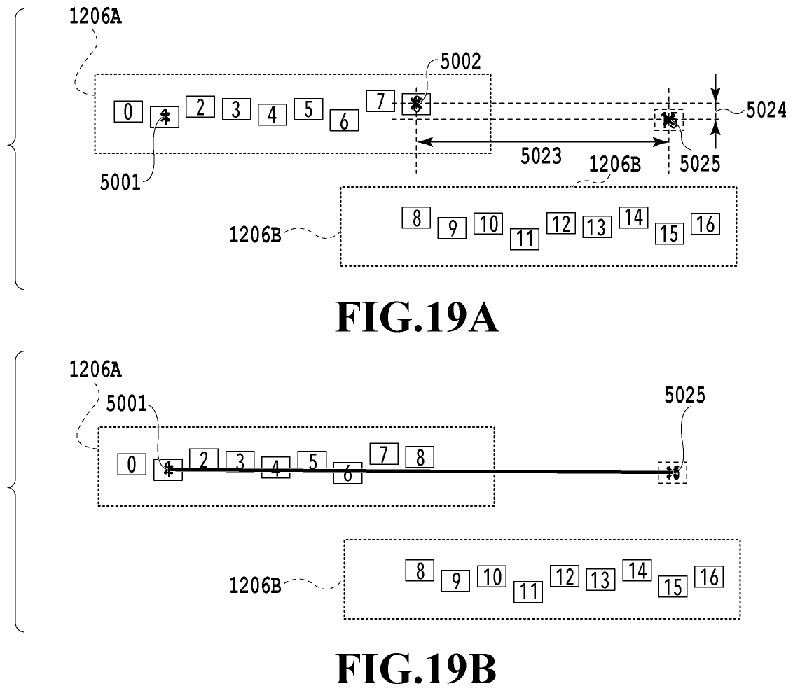

In S3205, the print controller 402 calculates, for the first scan image 2001, a tilt of a reference line for calculating amounts of positional shift between the printing element substrates 1002 and proceeds back to S3201. Details of S3205 will be described later using FIGS. 19A and 19B.

In S3206, the print controller 402 determines whether there is a test chart corresponding to the printhead 102 for which amounts of positional shift between its printing element substrates 1002 have yet to be calculated. If there is a test chart corresponding to the printhead 102 for which amounts of positional shift between its printing element substrates 1002 have yet to be calculated, the processing proceeds to S3207. If there is no test chart for the printhead 102 for which amounts of positional shift between its printing element substrates 1002 have yet to be calculated, the processing ends.

In S3207, the print controller 402 selects one of the test charts corresponding to the printheads 102 for which amounts of positional shift between their printing element substrates 1002 have yet to be calculated.

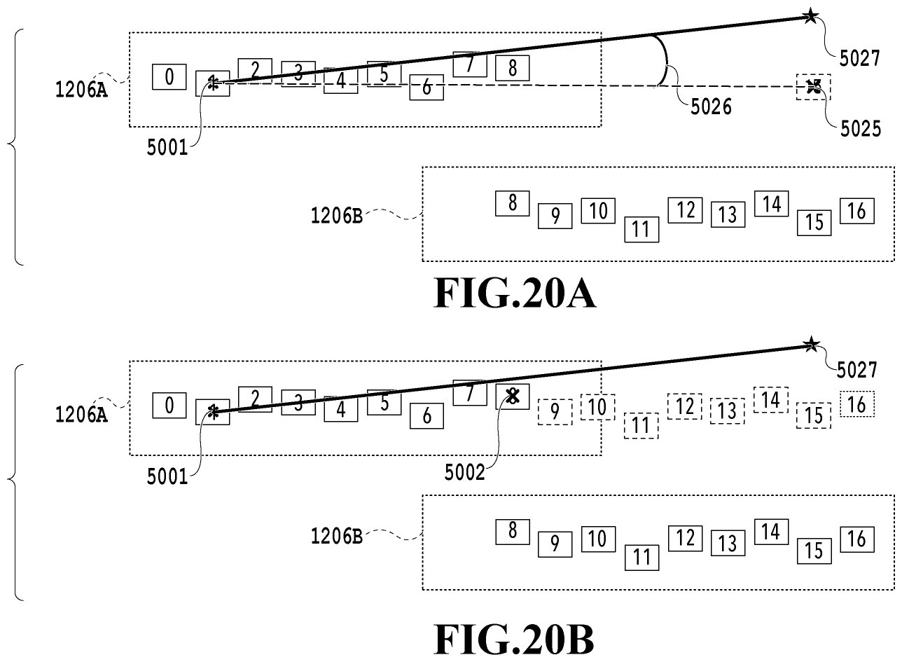

In S3208, the print controller 402 corrects the reference line for the test chart 1202 selected in S3207 so that the tilt of the reference line may be the same as the average tilt of the all the printheads 102. Details will be described later using FIG. 20A.

In S3209, the print controller 402 calculates the coordinates of each printing element substrate 1002 on the second scan image 2002 based on the coordinate system of the first scan image 2001. Details will be described later using FIG. 20B.

In S3210, using the reference line and the coordinate information on each printing element substrate 1002 in the coordinate system of the first scan image 2001 which have been obtained in the steps thus far, amounts of positional shift between all the printing element substrates 1002 are calculated based on the coordinate system of the first scan image.

FIGS. 18A, 18B, 19A, 19B, 20A, and 20B are diagrams illustrating the steps in FIG. 17. In these diagrams, the horizontal axis of the image is the X-axis, and the vertical axis is the Y-axis. The diagrams only show regions 1206A and 1206B on the first scan image 2001 and the second scan image 2002, extracted from the test chart 1206. The test chart 1206 is used as an example in the following description, but the same applies to the test charts 1207 to 1213 as well. In each scan image in the diagrams, the patches 1007 for the respective printing element substrates 1002 forming the test chart 1206 are depicted as rectangles having a number n thereinside to indicate that a Cn patch is printed by a Cn-th printing element substrate. Also, the positions of the patches 1007 for the respective printing element substrates 1002 indicate actual shifts.

FIG. 18A is a diagram illustrating the procedure for calculating position difference information on each printing element substrate 1002 on each scan image in S3203. To calculate position difference information, first, the representative position of one printing element substrate 1002 located in the overlap region of each scan image is determined as the origin. Then, the distance from the origin to the representative position of each of the printing element substrates 1002 is found for each of the X-axis and the Y-axis. In a case where the representative position of the C1 patch, namely a coordinate point 5001, is used as the origin on the first scan image 2001, for example, position difference information on the C8 patch whose representative position is a coordinate point 5002 has a difference 5003 along the X-axis and a difference 5004 along the Y-axis. On the second scan image, in a case where the representative position of the C8 patch, namely the coordinate point 5011, is used as the origin, for example, position difference information on the C15 patch whose representative position is a coordinate point 5012 has a difference 5013 along the X-axis and a difference 5014 along the Y-axis. Pieces of position difference information on C1 to C8 are saved for the first scan image 2001, and pieces of position difference information on C8 to C15 are saved for the second scan image. In this example, the origin used to calculate the position difference information is the representative position of the C1 patch for the first scan image 2001 and is the representative position of the C8 patch for the second scan image. It is favorable to use the representative position of the C1 patch as the origin for the first scan image 2001 because the origin used in correcting the reference line in S3208 is the representative position of the C1 patch. In S3209, the representative positions of the patches 1007 for the respective printing element substrates 1002 on the second scan image 2002 are calculated based on the coordinate system of the first scan image 2001. In this step, the C8 patch located in the overlap region is used as the boarder, and position difference information in relation to the C8 patch is used. This is why the representative position of the C8 patch is used as the origin for the second scan image 2002. Although the origins of the scan images are the representative position of the C1 patch and the representative position of the C8 patch in the present embodiment, the origins may be set anywhere as long as the calculation can be performed similarly. Also, as to the patches 1007 for the printing element substrates 1002 located only in one of the scan images, position difference information is saved only for the corresponding scan image. As to the patches 1007 for the printing element substrates 1002 located in the overlap region, only position difference information on the patch 1007 used as the border is saved for both of the scan images, and position difference information on the other patches 1007 is saved for one of the scan images. The border is the C8 patch in the example described above.

FIG. 18B is a diagram illustrating the procedure in S3204 for converting position difference information for the second scan image 2002 based on the position difference information for the second scan image 2002 and the corresponding rate of extension/contraction K to bring the rate of extension/contraction to 1. Because the rate of extension/contraction between the first scan image 2001 and the second scan image 2002 has already been calculated for each of the test charts 1202 in S3109, its value is used as a correction value for the second scan image 2002. The distance between particular patterns on the second scan image 2002 is converted to be equal to the distance between the same corresponding particular patterns on the first scan image 2001. Specifically, the position difference information is corrected by being multiplied by the rate of extension/contraction K corresponding to the difference 5014. More specifically, the position difference information is corrected so that, as shown in FIGS. 16A and 16B, the distance SR between the R0 patterns on the C8 patch on the first scan image 2001 and the distance ER between the R0 patterns on the C8 patch on the second scan image 2002 may become equal. Corrected position difference information on each printing element substrate 1002 on the second scan image 2002 can be calculated by multiplying position difference information by, if any, the rate of extension/contraction corresponding to the uncorrected position difference information obtained in S3203.

Position difference information having the representative position of the C8 patch as the origin is corrected so that the distance between particular patterns on the second scan image 2002 may become equal to the distance between the same corresponding particular patterns on the first scan image 2001. For instance, for the C15 patch, its representative position after correction is a coordinate point 5022. Specifically, the corrected position difference information on the C15 patch has been converted to have a difference 5023 along the X-axis and a difference 5024 along the Y-axis.

FIGS. 19A and 19B are diagrams illustrating a procedure of how the reference line is obtained in S3205. Here, a procedure for obtaining the reference line in the coordinate system of the first scan image 2001 is described. First, it is necessary that the coordinate point of the C15 patch needed to obtain the reference line be calculated based on the coordinate system of the first scan image 2001. In S3204, the distance between particular patterns on the first scan image 2001 has already been made to equal the distance between the same corresponding particular patterns on the second scan image 2002. Thus, the coordinate point of the C15 patch can be calculated by adding the position difference information on the C15 patch on the second scan image 2002 to the position difference information on the C8 patch on the first scan image 2001. Specifically, the X-coordinate of the C15 patch in the coordinate system of the first scan image 2001 is the sum of the difference 5003 and the difference 5023, and the Y-coordinate of the C15 patch in the coordinate system of the first scan image 2001 is the sum of the difference 5004 and the difference 5024. A coordinate point 5025 in FIG. 19A is position difference information on the C15 patch in the coordinate system of the first scan image 2001. As shown in FIG. 19B, a line connecting the coordinate point 5001 of the C1 patch, which is the origin on the first scan image 2001, and the thus-obtained coordinate point 5025 of the C15 patch is a reference line for the corresponding printhead 102. Although the above describes a procedure for obtaining a reference line in the coordinate system of the first scan image 2001, the reference line can be obtained similarly based on the coordinate system of the second scan image 2002. In the coordinate system of the second scan image 2002, the coordinate point of the C1 patch needs to be found to find the reference line, and this is found using the difference 5003 and the difference 5004. Note that the reference line may be found based on a third coordinate system, which is neither the coordinate system of the first scan image 2001 nor the coordinate system of the second scan image, as long as positional information can be obtained in the common coordinate system.

FIG. 20A is a diagram illustrating how a tilt of the reference line is corrected in S3208. In the present embodiment, in the process of calculating amounts of positional shift between the printing element substrates 1002, a tilt of the printhead 102 is corrected. An amount of correction of a tilt of each printhead 102 is found based on a difference between the average tilt of all the printhead 102 and the tilt of the printhead 102, as described earlier. Tilts of the respective printheads 102 are obtained in S3205, based on which the average tilt of all the printheads 102 is obtained. A coordinate point 5027 shown in FIGS. 20A and 20B is a point obtained by rotating the coordinate point 5025 about the coordinate point 5001 as the origin by an angle 5026, which is a tilt correction amount for the printhead 102. Thus, a line connecting the coordinate point 5001 and the coordinate point 5027 is the final reference line used to calculate amounts of positional shift between the printing element substrates 1002.

FIG. 20B is a diagram illustrating a procedure for calculating, in S3209, the coordinates of each printing element substrate 1002 on the second scan image 2002 based on the coordinate system of the first scan image 2001. To calculate amounts of positional shift between the printing element substrates 1002 in relation to the reference line obtained, the coordinate points of all the printing element substrates 1002 on the second scan image 2002 need to be calculated based on the coordinate system of the first scan image 2001. To this end, the position difference information on each printing element substrate 1002 on the second scan image 2002 recalculated in S3203 is used. This procedure is the same as the procedure for calculating the coordinate point of C15 in the coordinate system of the first scan image 2001 in S3205. Using the reference line thus obtained and the coordinate points of the respective printing element substrates 1002, which are their position difference information, amounts of positional shift between all the printing element substrates 1002 can be calculated in S3210.

According to the inkjet printing apparatus of the present invention described above, amounts of positional shift of the printheads can be calculated accurately even in a case where the scanner device has a plurality of sensors and scans test charts into a plurality of scan images.

Although the scanner device in the present embodiment has two sensors, the present invention can be applied to a mode where the scanner device has three or more sensors as long as scan images obtained by adjacent sensors have overlap regions including a test chart.

Also, although the present embodiment performs processing necessary for calculating amounts of positional shift between the printing element substrates, the present invention can be applied to calculation of other correction amounts as long as a reference line for finding the correction amounts extend over a plurality of scan images.

Also, although an inkjet printing apparatus is used as an example of a printing apparatus, the method for applying a printing material is not limited to the inkjet method that ejects ink, and the technique of the present invention can be applied to printing apparatuses using other printing material application methods.

### OTHER EMBODIMENTS

Although the inkjet printing apparatus 100 in the present embodiment described above has a plurality of printheads 102, the inkjet printing apparatus may have a single printhead 102. The printhead 102 does not have to be a full-line head, but may be a printhead 102 of a serial type that forms an image of ink by ejecting ink while a carriage to which the printhead 102 is detachably mounted moves in the Y-direction. The printing medium P may be a sheet of paper, and in that case, the printing apparatus has a conveyance mechanism suitable for handling sheets of paper.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

The present disclosure can adjust print positions properly even in a case where a test chart printed on a printing medium is scanned in a divided manner.

This application claims the benefit of Japanese Patent Application No. 2023-092523 filed Jun. 5, 2023, which is hereby incorporated by reference wherein in its entirety.

What is claimed is:

1. A printing apparatus comprising:
one or more printing units including a plurality of printing element substrates that apply a printing material to a printing medium;
a scan control unit that causes a scan device to scan a test chart in a divided manner with a plurality of optical sensors, the test chart being printed on the printing medium by the printing unit and including a plurality of patches corresponding to the respective printing element substrates;
a calculation unit that, based on a plurality of scan images obtained by the scan device by scanning the test chart printed on the printing medium, calculates a rate of extension or contraction of the patches corresponding to the printing element substrates included in the same printing unit, the rate of extension/contraction being between a pair of scan images formed by two of the plurality of scan images; and
an adjustment unit that adjusts positions where the printing material applied from the printing unit attaches to the printing medium based on the rate of extension or contraction calculated by the calculation unit and positional information on the patches on the plurality of scan images.

2. The printing apparatus according to claim 1, wherein
the patches corresponding to the printing element substrates included in the same printing unit are included in overlap regions of the pair of scan images, the overlap regions being a same portion of the test chart scanned in an overlapping manner.

3. The printing apparatus according to claim 2, wherein
the patches corresponding to the printing element substrates included in the same printing unit are patches corresponding to the same printing element substrate included in the same printing unit.

4. The printing apparatus according to claim 2, wherein
the adjustment unit converts positional information on the patches on one of the pair of scan images to bring the rate of extension or contraction of the patches to 1, and
based on the positional information on the patches in the overlap regions, the adjustment unit combines the positional information on the patches on the pair of scan images.

5. The printing apparatus according to claim 4, wherein
based on the combined positional information on the patches, the adjustment unit calculates an amount of positional shift of a position where the printing material attaches, and
based on the amount of positional shift, the adjustment unit adjusts a position where the printing material applied by the printing unit attaches.

6. The printing apparatus according to claim 5, wherein
the amount of positional shift include an amount of positional shift calculated based on a reference line connecting positions of the patches corresponding to predetermined two of the printing element substrates in the combined positional information on the patches.

7. The printing apparatus according to claim 6, wherein
the reference line is a line connecting positions of patches for two different ones of the printing element substrates included in the same printing unit.

8. The printing apparatus according to claim 6, wherein
the positions of the two patches forming the reference line are represented with coordinate points based on a single common coordinate system.

9. The printing apparatus according to claim 6, wherein
the positions of the two patches forming the reference line are represented as differences each indicating a distance from a position of a predetermined patch located in the overlap region.

10. The printing apparatus according to claim 6, wherein
in a case where the printing apparatus has a plurality of the printing units, the adjustment unit corrects the reference line so that a tilt of the reference line becomes same as an average tilt of the plurality of printing units.

11. The printing apparatus according to claim 1, wherein
the printing element substrates each have an array of ink-ejecting nozzles.

12. The printing apparatus according to claim 1, wherein
the pair of scan images is formed of two scan images obtained by two adjacent ones of the optical sensors in the scan device.

13. A printing method for a printing apparatus having a printing unit or a plurality of the printing units including a plurality of printing element substrates that apply a printing material to a printing medium, the printing method comprising:
causing a scan device to scan a test chart in a divided manner with a plurality of optical sensors, the test chart being printed on the printing medium by the printing unit and including a plurality of patches corresponding to the respective printing element substrates;
based on a plurality of scan images obtained by the scan device by scanning the test chart printed on the printing medium, calculating a rate of extension or contraction of the patches corresponding to the printing element substrates included in the same printing unit, the rate of extension/contraction being between a pair of scan images formed by two of the plurality of scan images; and
adjusting positions where the printing material applied from the printing unit attaches to the printing medium based on the rate of extension or contraction calculated in the calculating and positional information on the patches on the plurality of scan images.

14. A non-transitory computer readable storage medium storing a program that causes a computer to execute a printing method for a printing apparatus having a printing unit or a plurality of the printing units including a plurality of printing element substrates that apply a printing material to a printing medium, the printing method comprising:
causing a scan device to scan a test chart in a divided manner with a plurality of optical sensors, the test chart being printed on the printing medium by the printing unit and including a plurality of patches corresponding to the respective printing element substrates;
based on a plurality of scan images obtained by the scan device by scanning the test chart printed on the printing medium, calculating a rate of extension or contraction of the patches corresponding to the printing element substrates included in the same printing unit, the rate of extension/contraction being between a pair of scan images formed by two of the plurality of scan images; and
adjusting positions where the printing material applied from the printing unit attaches to the printing medium based on the rate of extension or contraction calculated in the calculating and positional information on the patches on the plurality of scan images.
